(19) United States
(12) Patent Application Publication
(10) Pub. No.: US 2023/0026479 A1
(43) Pub. Date: Jan. 26, 2023

(54) Crowdsourced Cinematic Universe Model

(71) Applicants: Jan Lucanus Childress, North Hollywood, CA (US); Andra Roxana Stanciu, North Hollywood, CA (US); Autumn Noel Kelly, North Hollywood, CA (US)

(72) Inventors: Jan Lucanus Childress, North Hollywood, CA (US); Andra Roxana Stanciu, North Hollywood, CA (US); Autumn Noel Kelly, North Hollywood, CA (US)

(73) Assignee: ReelwUrld, Inc., New York, NY (US)

(21) Appl. No.: 17/384,708

(22) Filed: Jul. 24, 2021

(51) Int. Cl. G11B 27/031; H04N 5/222

(52) U.S. Cl. CPC G11B 27/031; H04N 5/2222

(57) ABSTRACT

A storytelling system that simplifies the filmmaking process to enable end-users, including, but not limited to, audiences of movies, TV shows, and commercials, and product-narrative owners, including, but not limited to studios, TV networks, filmmakers, and brands, to co-produce audio-visual stories as extensions of existing product-narratives. The system includes, but is not limited to, story prompts that direct end-users' filmmaking activities, protocol to frame creation of audio-visual stories within the product-narrative, a function for end-users to choose relationship status between one another within the product narrative, and a method to catalogue activity within the system, which can be delivered in varying formats. The system includes, but is not limited to, a method for product-narrative owner to organize end-user's audio-visual story, a plurality of end-user audio-visual stories, the product-narrative, and/or any combination thereof, to articulate expanded product-narrative as a result of the system.

### TECHNICAL FIELD

The current disclosure of the invention relates to a system, processes, and methods for teaching cinematic storytelling, more particularly, as related to a movie or series of movies, a TV show, or a commercial and the impact thereof upon an audience or community, through the use of prompts that direct end-users to create characters and audio-visual stories set within the narratives of larger media products.

### BACKGROUND

The invention is a result of inventor Jan Lucanus Childress' upbringing and lifelong career in the entertainment industry, specifically the comic book, film & television, music, and gaming industries. Jan observed that each industry was suffering from the same challenge: getting their respective audiences to engage with a particular product. Concurrently, Jan observed that members of the audience, now equipped with tools such as social media, were more empowered than ever to tell their own stories, which are more prominent in their lives than any product's narrative.

His solution: apply the directorial process of filmmaking to the audience members, as a director would an actor in a scene. This solution required a brand or product-owner in a particular industry would need a system to house a story or product-narrative, centralize its target audience, distribute directions to the audience, and receive, log, store, and display the audience activity within that narrative. Concurrently, for the audience to be centralized within the system, there must be a value proposition that augments their individual narratives.

The invention includes, but is not limited to, a system of processes that allow the narrative of a product to dynamically integrate with the narrative of its intended audience. The product owner and the audience members are then all positioned as storytellers, with the product's storyteller guiding a product-narrative composed of, but not limited to, product-related stories created by audience members using prompts generated by the invention. Products utilized by our system can include, but are not limited to, a movie, a television series, an album, a game, or even a story happening in real-time, including, but not limited to, that of a political campaign.

Prior Art includes diagrams, videos, and public discussions given by Jan Lucanus Childress on the subjects of “Transmedia Trifecta”, “Open Collaborative Narrative Universe (OCNU)”, and other general discussions. However, the Prior Art only contains generalizations of the challenges and solutions that the invention addresses. Additionally, since 2018, inventor Jan Lucanus Childress has used the invention, without publicly disclosing trade secret methods of ideation, organization, and execution afforded by the invention, to produce a show called Justice For Hire (JFH) that allows for anyone with a camera phone to join the cast and produce cinematic stories to expand the story world of the show. This provisional patent application marks the first time the specifics of the invention's system, including, but not limited to, its processes, interface, and output, are being articulated for public disclosure

### BRIEF SUMMARY

The invention provides a brand with a means to conduct its audience through filmmaking. The invention intentionally frames the brand's content to motivate the audience to create original content. The invention can be constructed and utilized in a format, including, but not limited to paper, cards, video, a website, app, or online digital platform that allows the audience to unite in producing, displaying, and sharing thematically connected, story-driven audio/visual content, including but not limited to movies and short videos, that are directed by story prompts drawn from the invention's processes and rules that align with the brand.

### SUMMARY

What does the Invention Do?

Managing an audience can be challenging for brands with products that have a strong fanbase. If the fans are displeased by how the brand handles the product, the brand could lose money and brand affinity. Concurrently, many fans desire to participate in the product's narrative, but brands, notably film studios and television networks, often struggle with the process of meaningful collaborations with fan communities. The invention allows fans and brands to collaborate on thematic content creation.

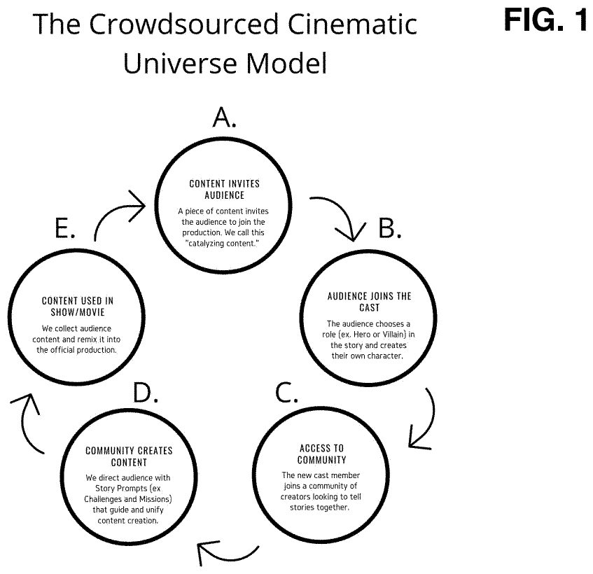

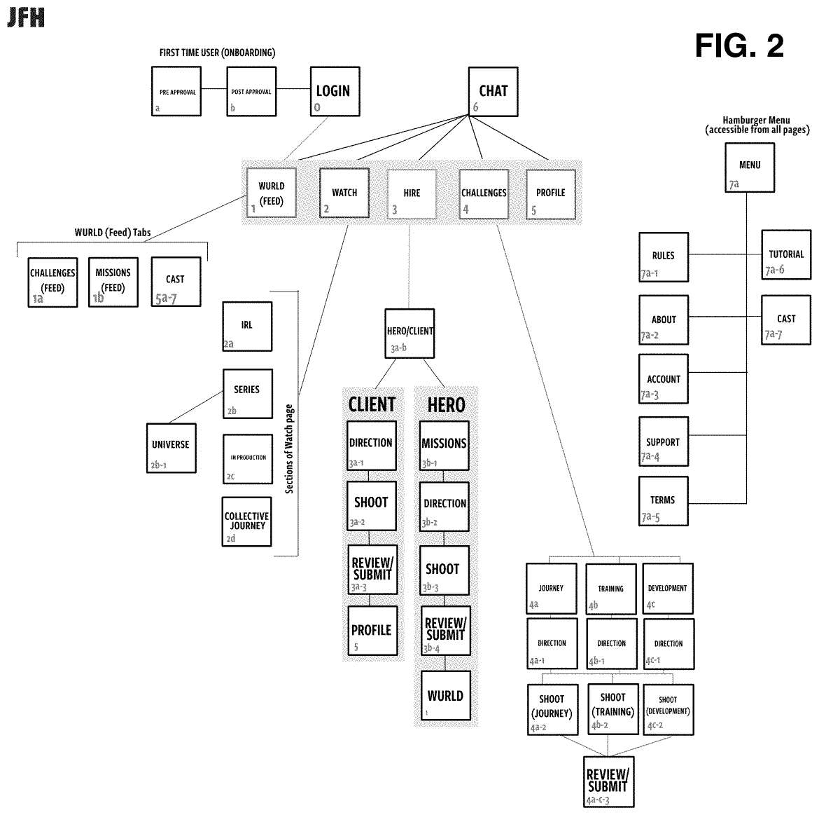

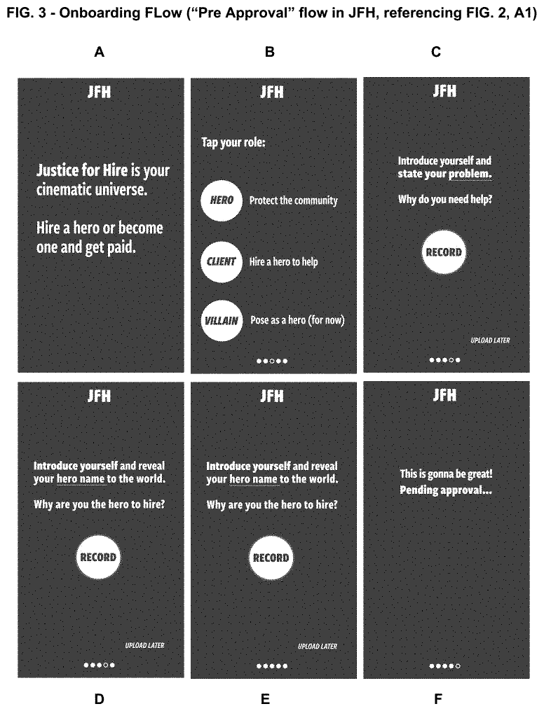

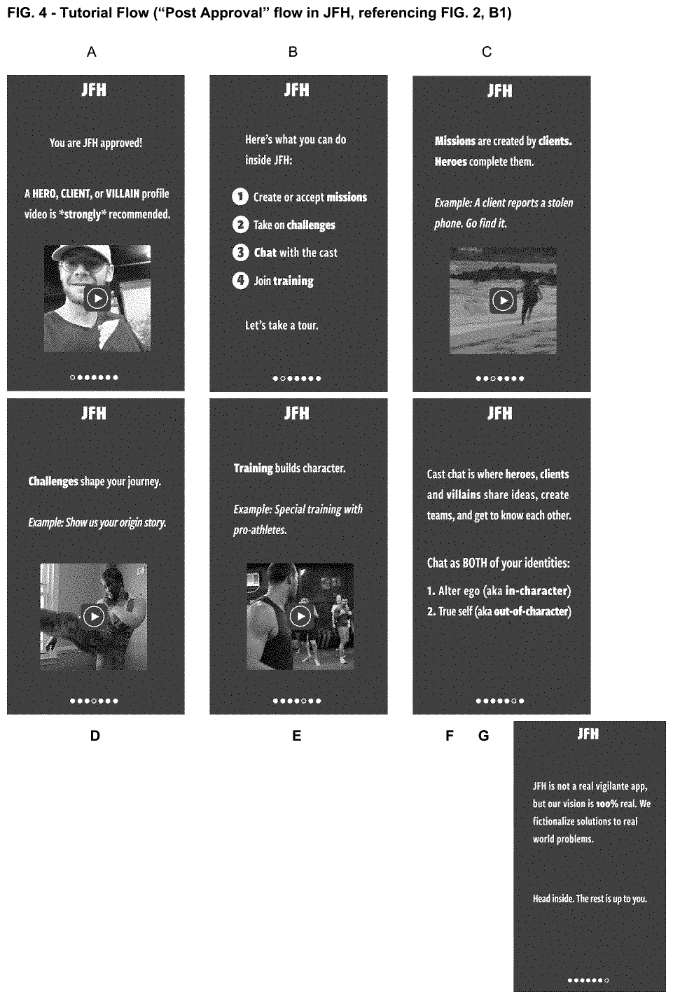

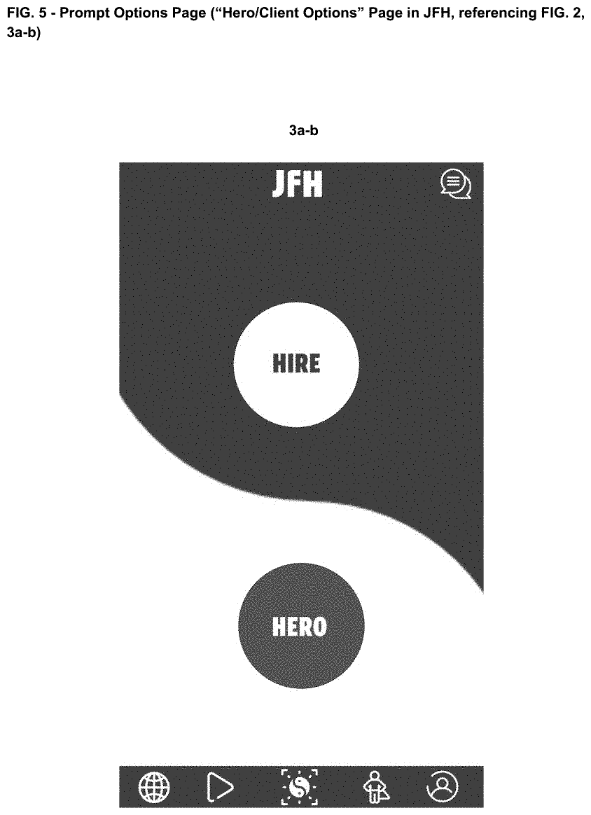

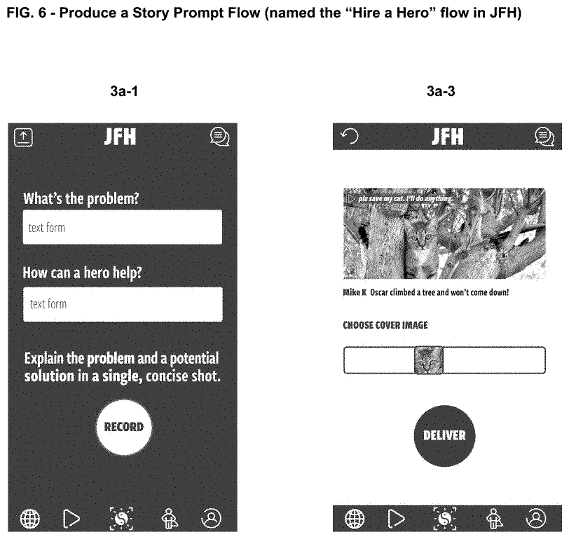

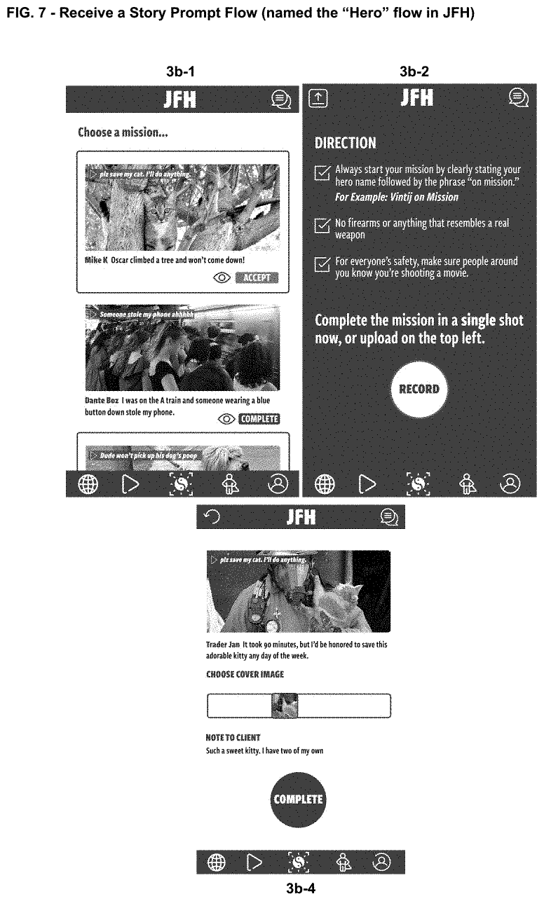

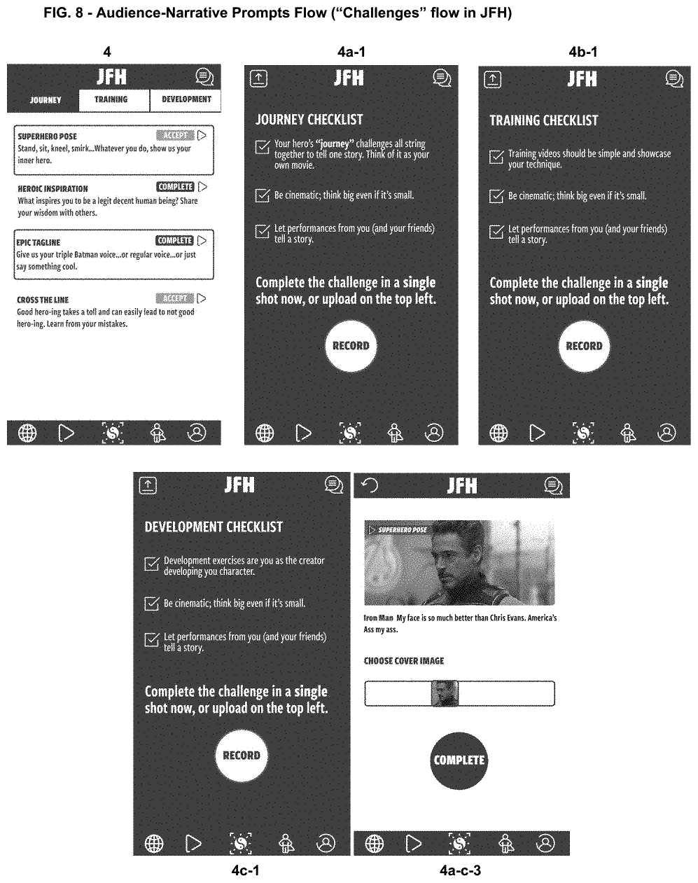

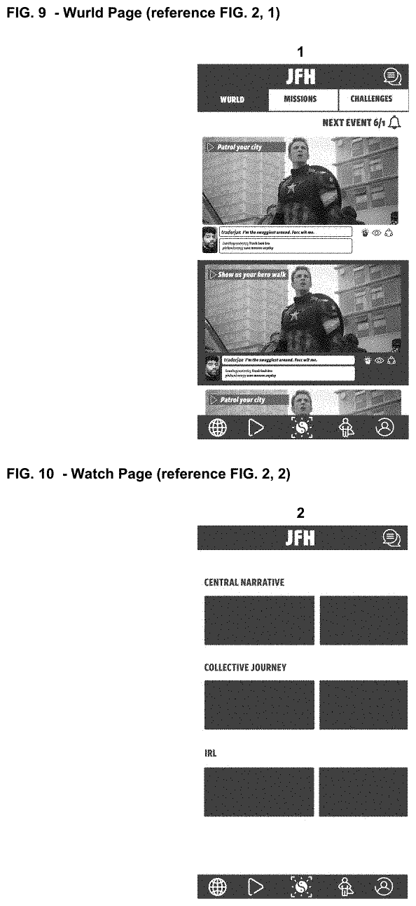

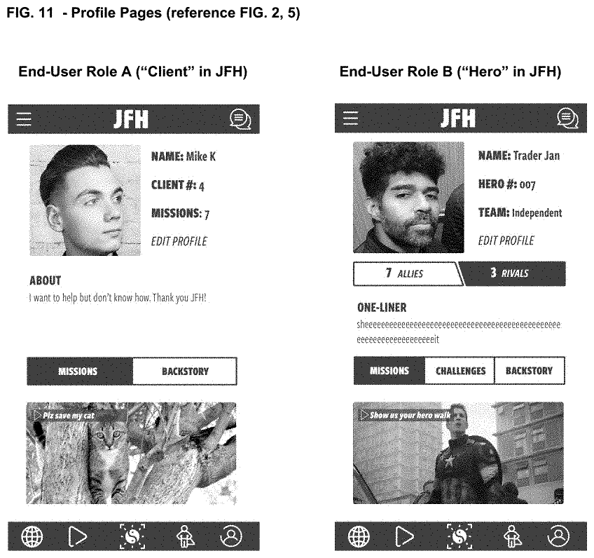

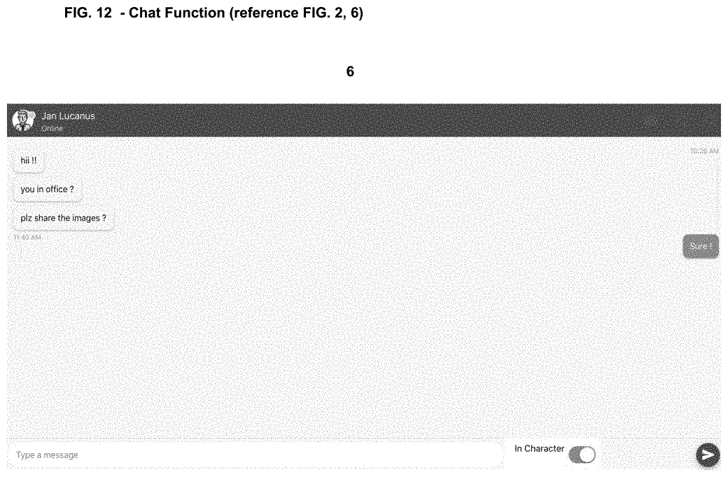

The invention is a system (embodiment FIG. 1), which can include, but is not limited to, an app & online digital filmmaking & crowdsource technology platform (embodiment FIG. 2), that connects storytellers (including, but not limited to, product-owning brands) and their audiences (including, but not limited to, fans) and includes, but is not limited to, storytelling, filmmaking & directorial processes that are simplified and customized on behalf of a given storyteller's product-narrative (examples include, but are not limited to, the story of a film or film franchise, TV show, or political campaign) into end-user (i.e. individual audience member) prompts (embodiments FIG. 2, 3a-1, 3a-3, 3b-1, 3b-2, 4, 4a, FIG. 5, FIG. 6, and FIG. 7) that direct the end-user to produce audio/visual storytelling content on devices that include, but are not limited to smart phones, tablets, and cameras. The resulting end-user content, including, but not limited to audio/visual text, image, and video content (embodiment FIG. 2, 3a-2, 3b-3, 4a, 4b, 4c), having been produced within the system of this invention, contains storytelling elements that are both unique to the end-user and thematically tied to the product-narrative, which is then distributed for display within, but not limited to, the system's distribution platforms (embodiment FIG. 1.2).

To deepen the impact of an end-user's experience within the product-narrative, an embodiment of the invention can include, but is not limited to, allowing the end-user to choose a role (i.e. create a character, persona, or alter ego) that is thematically aligned with the product-narrative (embodiment FIG. 3, B), by a variety of means, including, but not limited to, using a prompt to direct the end-user to produce video or other audio/visual content in which the end-user chooses a role. This “choose a role” function of the invention, when utilized, serves a variety of purposes, including, but not limited to, psychologically engaging the end-user upon their initial contact with the app & online digital platform to creatively invest in the product-narrative.

Additionally, an embodiment of the invention allows end-users to communicate with each other in a variety of sections of the app & online digital platform, including but not limited to a Chat Function (FIG. 2, 6) in which a toggle functionality allows the end-user to choose between sending messages “in-character” (i.e. their chosen role) or “out-of-character” (i.e. as the end-user's true identity). The implications of the “toggle chat” functions include, but are not limited to, the encouragement of fan communication and audience transparency in collaboration with each other and the brand's product narrative.

The invention allows for audience conduction (serving the brand) and audience participation (serving the fans of a brand's product) by means of a cohesive narrative experience expressed through guided audio/visual content creation and community collaboration. A novel application for the invention includes, but is not limited to, a film or television show expanding its narrative by collaborating with its audience to create new characters and stories, in which the audience acts within short videos that are produced with direction via prompts within the app & online digital platform.

### DESCRIPTION OF THE IMAGES

Figures are briefly described in this section, and later described in greater detail in the Detailed Description section beneath it.

FIG. 1 depicts an embodiment of the invention for general conversation purposes, intentionally leaving out the greater details of the invention's systems and methodologies.

FIG. 2 depicts an embodiment of the invention's system in the form of the app & online digital filmmaking and crowdsource technology platform.

FIG. 3 depicts an embodiment of the Onboarding flow (“Pre Approval” flow in JFH). FIG. 4 depicts an embodiment of the Tutorial flow (“Post Approval” flow in JFH).

FIG. 5 is an embodiment of the end-user's Prompt Options Page (“Hero/Client Options” Page in JFH).

FIG. 6 is an embodiment of the Produce a Story Prompt flow (named the “Hire a Hero” flow in JFH).

FIG. 7 is an embodiment of the Receive a Story Prompt flow (named the “Hero” flow in JFH).

FIG. 8 is an embodiment of the Audience-Narrative Prompts flow (named the “Challenges” flow in JFH).

FIG. 9 is an embodiment of the Wurld page.

FIG. 10 is an embodiment of the Watch page.

FIG. 11 is an embodiment of the Profile Pages.

FIG. 12 is an embodiment of the Chat Function.

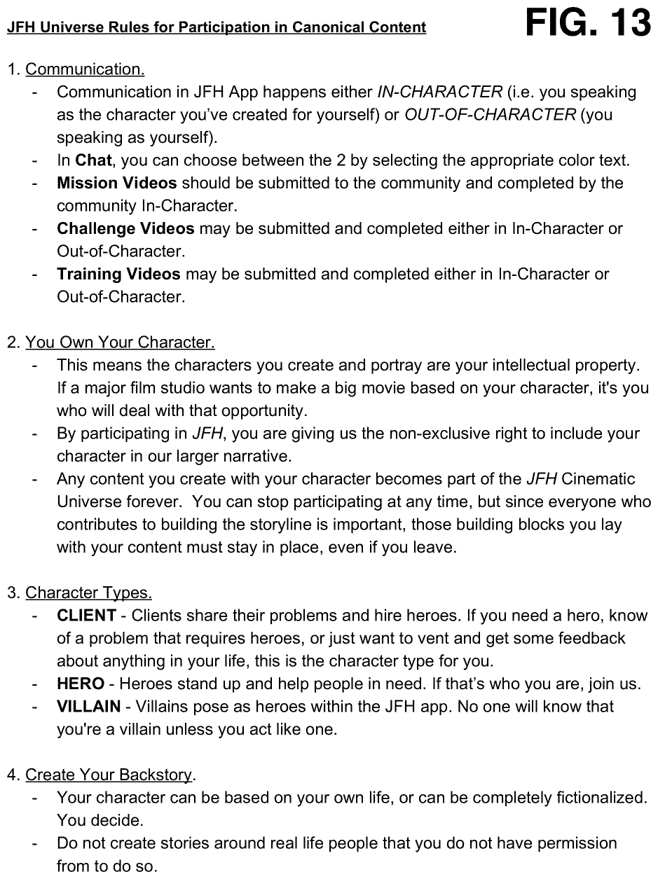

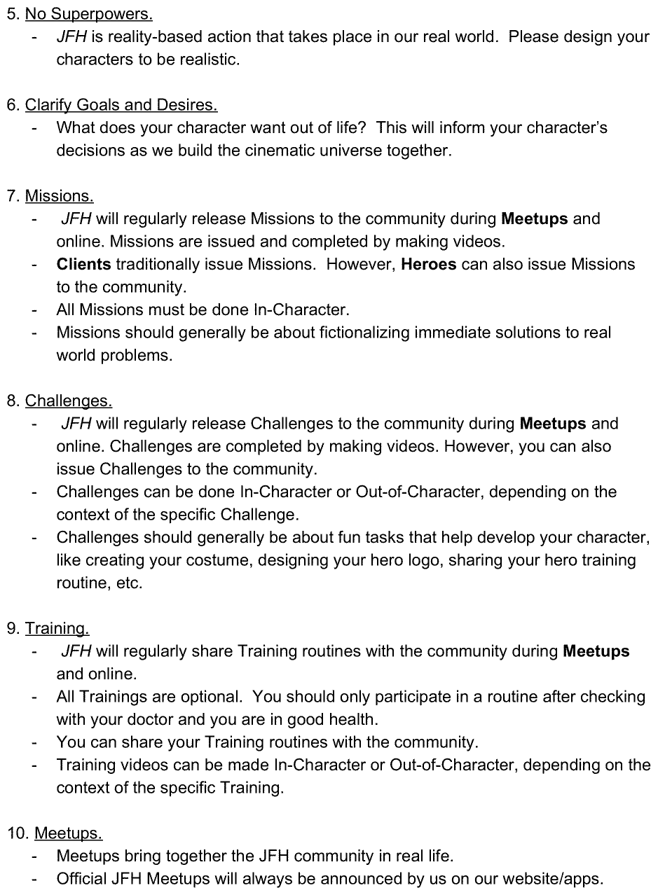

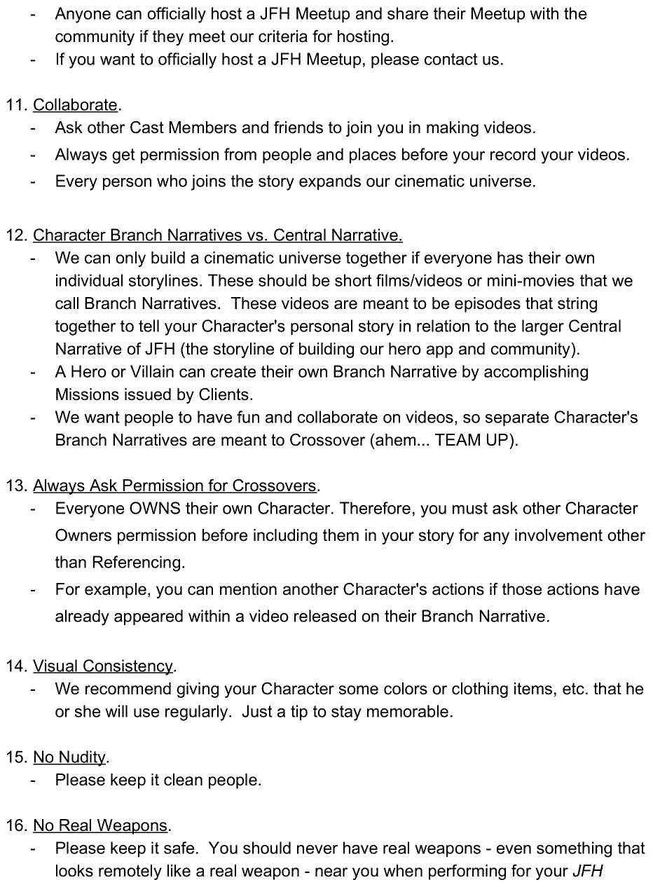

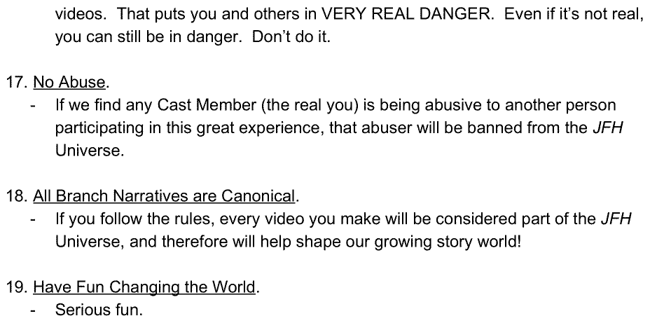

FIG. 13 is an embodiment of the Universe Rules, to articulate unique aspects of the invention's processes.

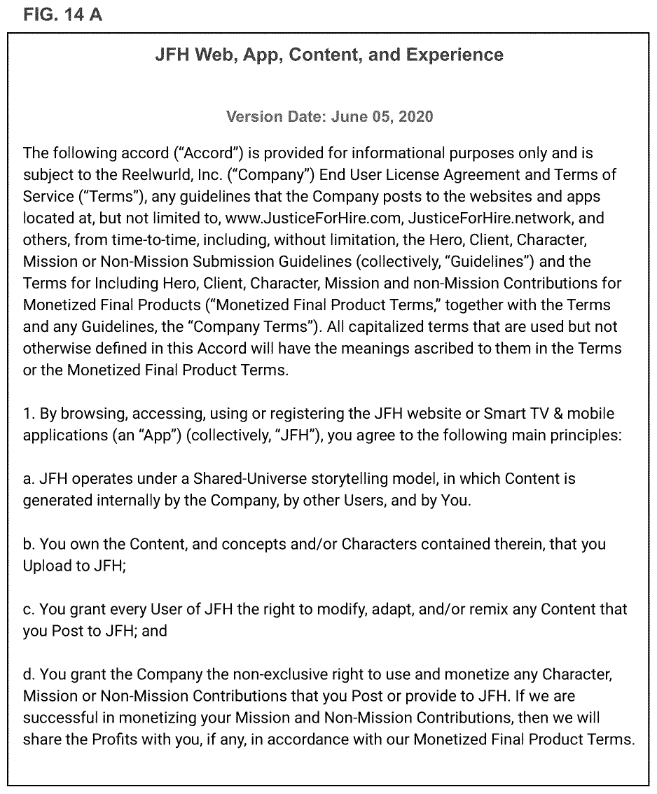

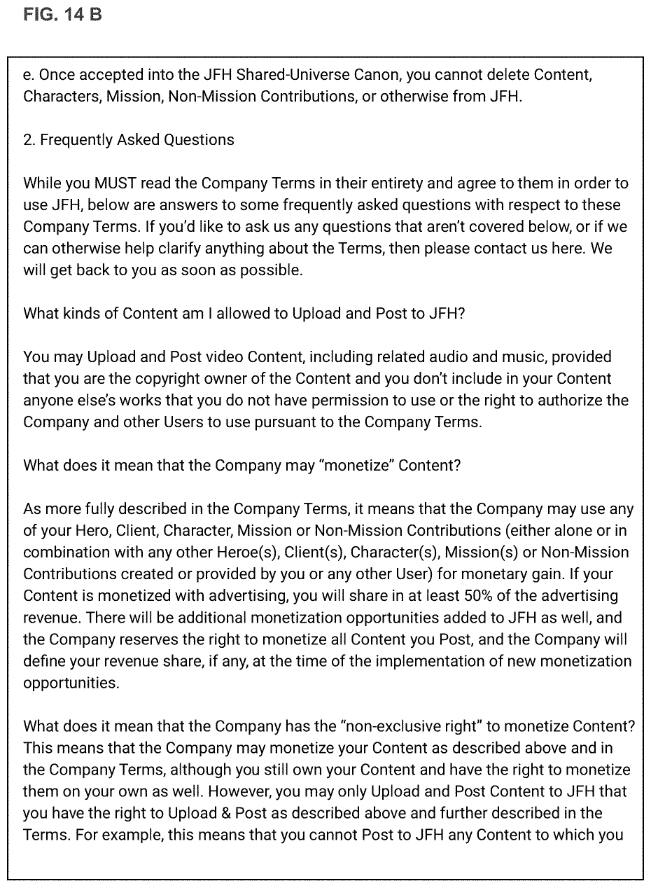

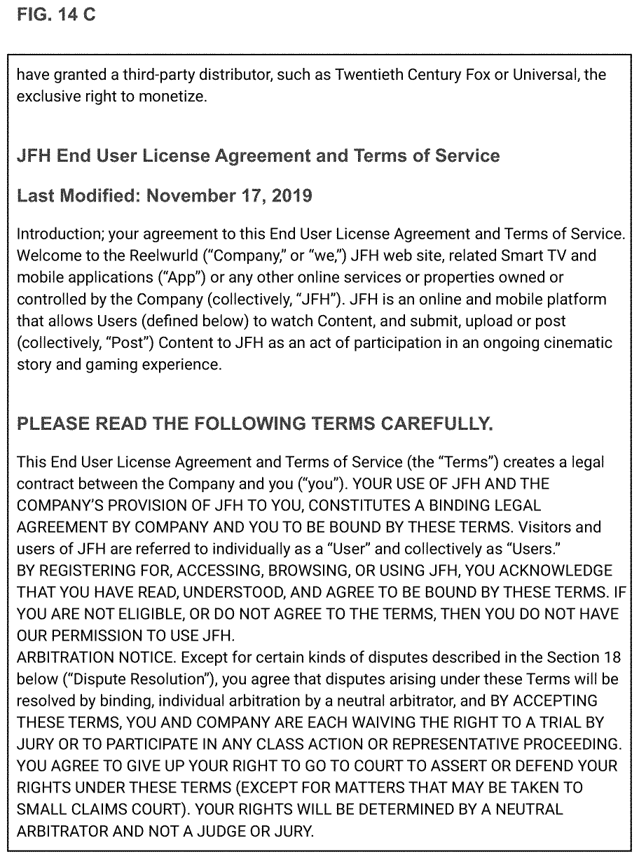

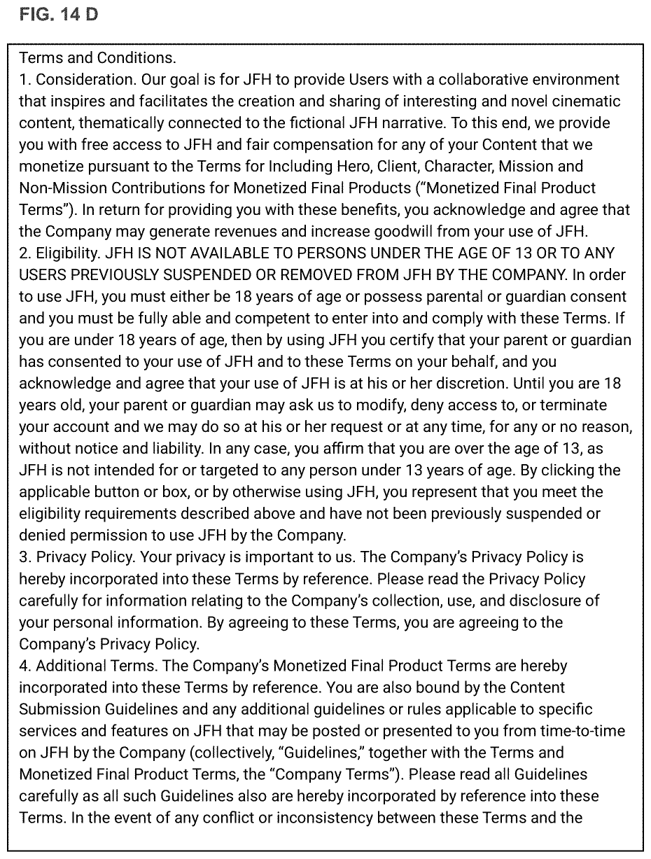

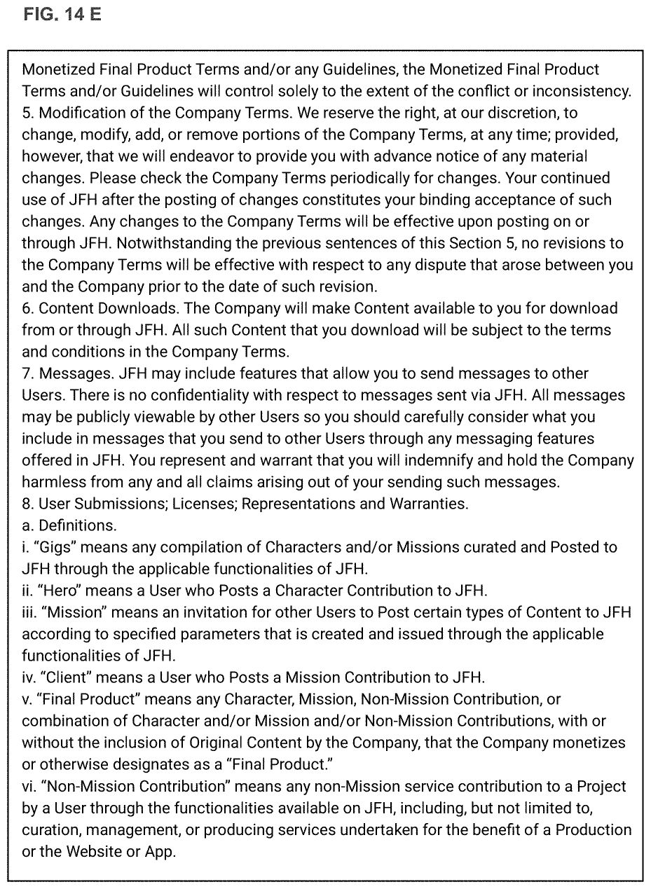

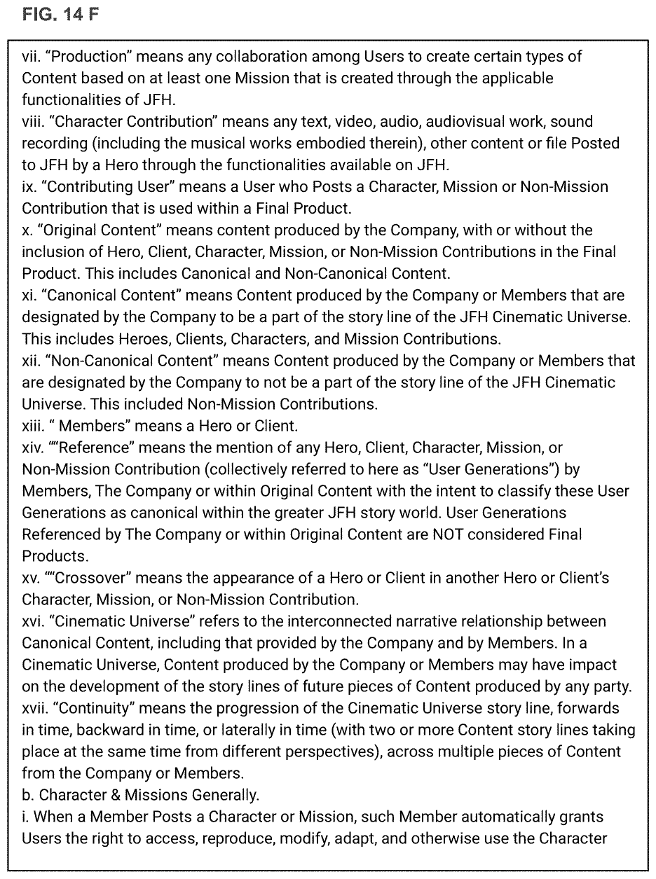

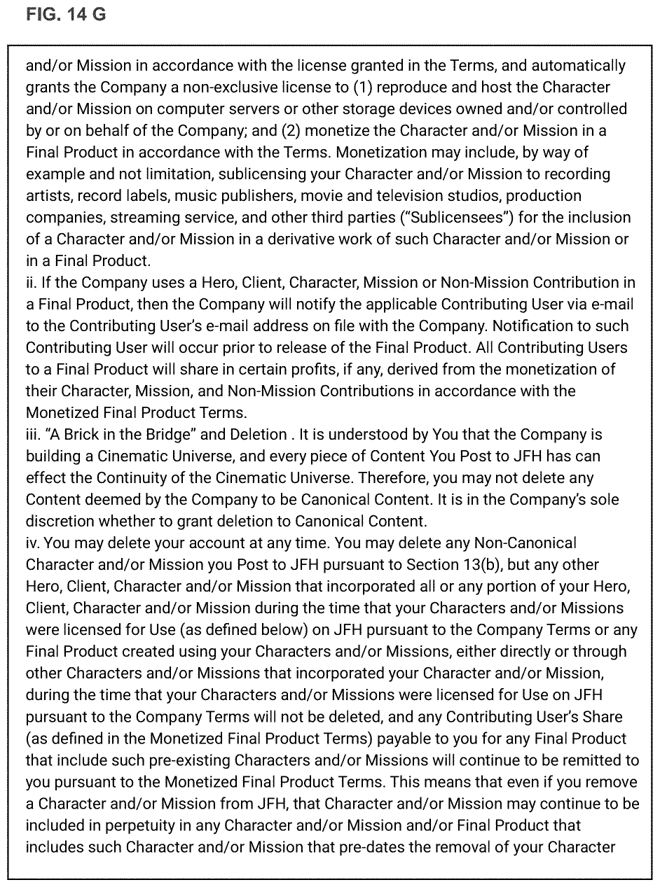

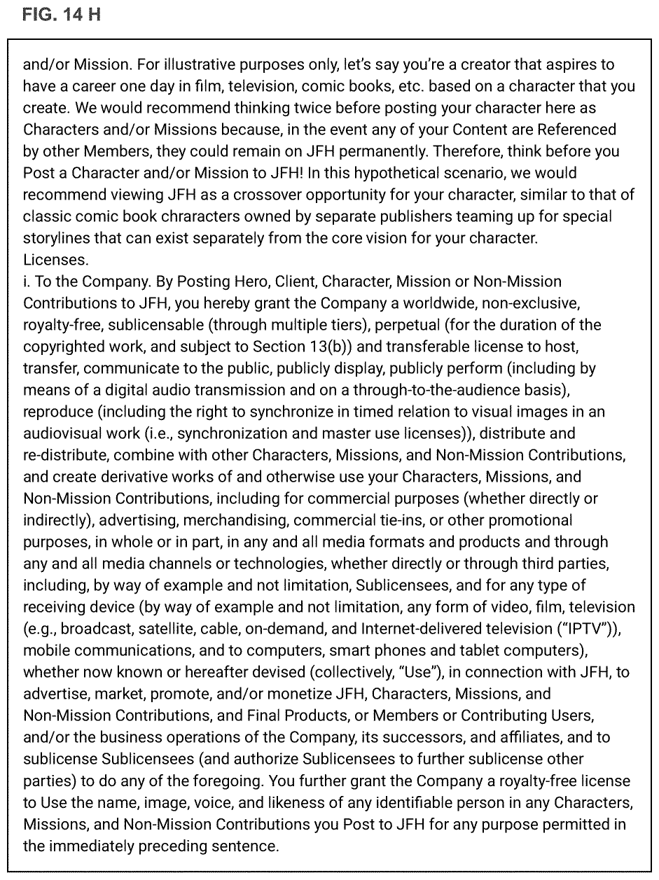

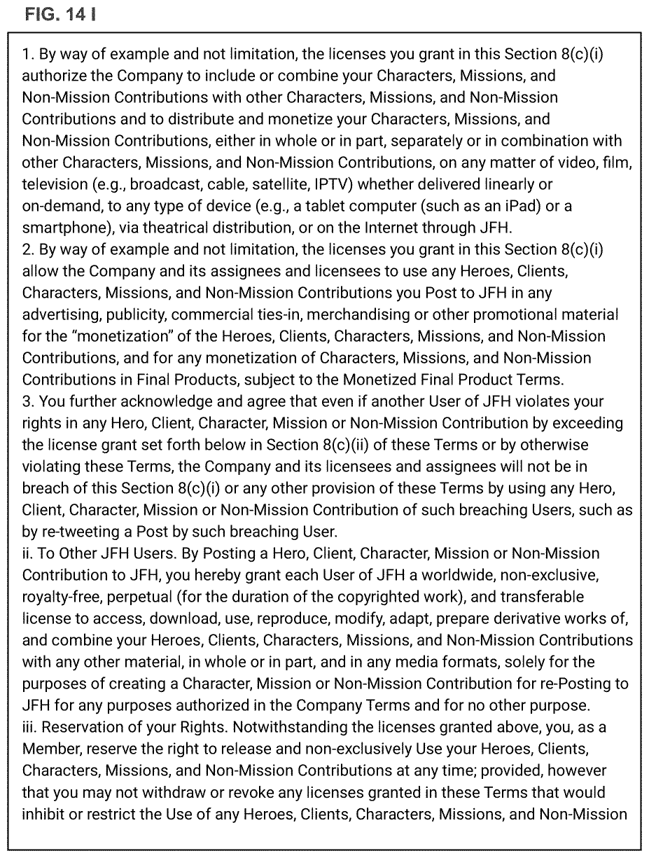

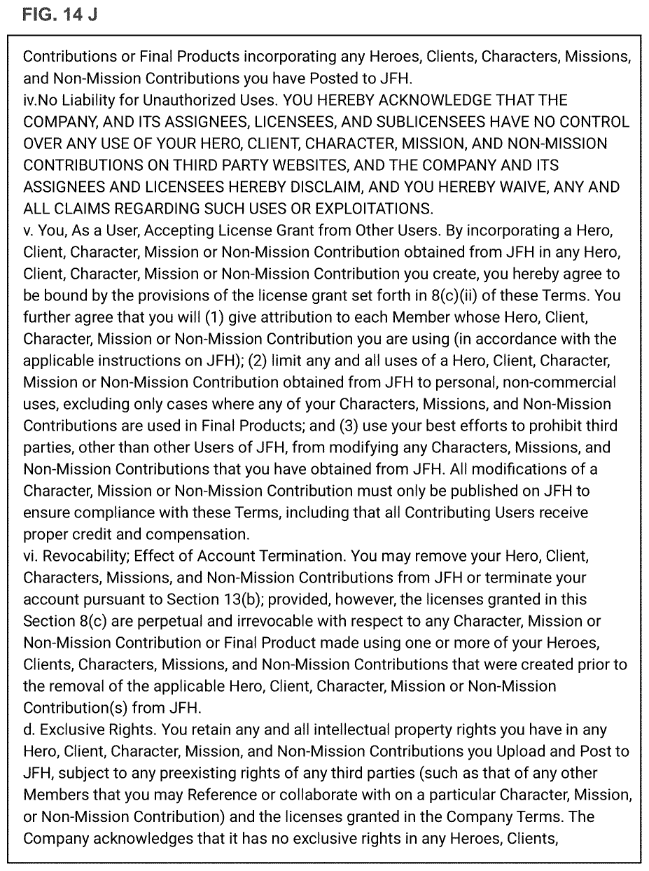

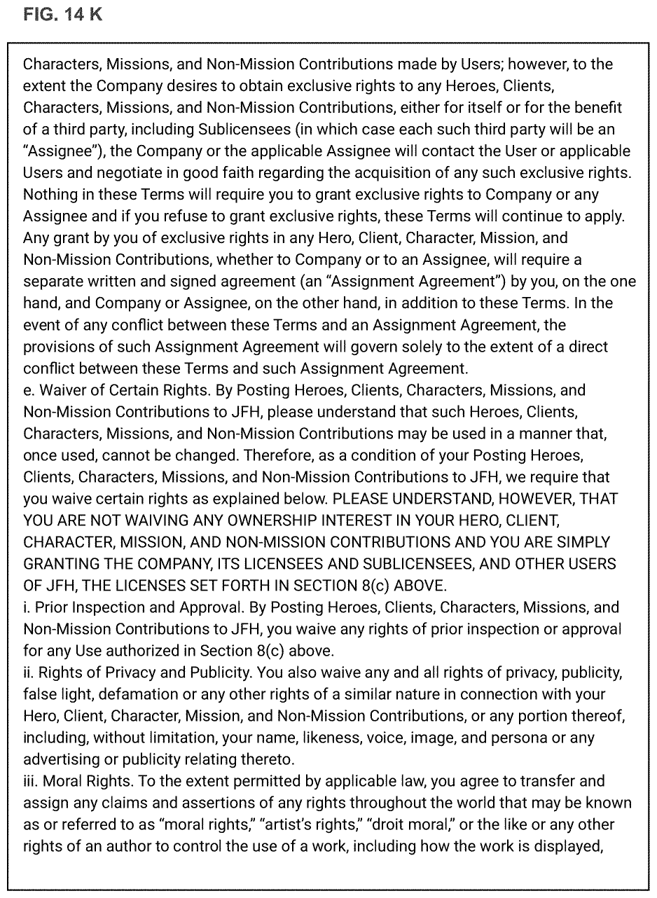

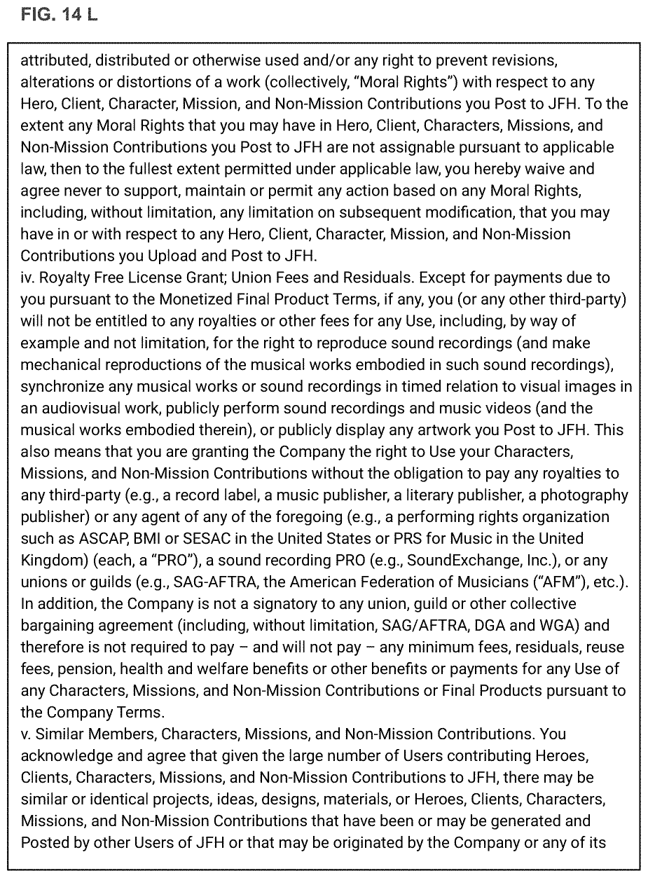

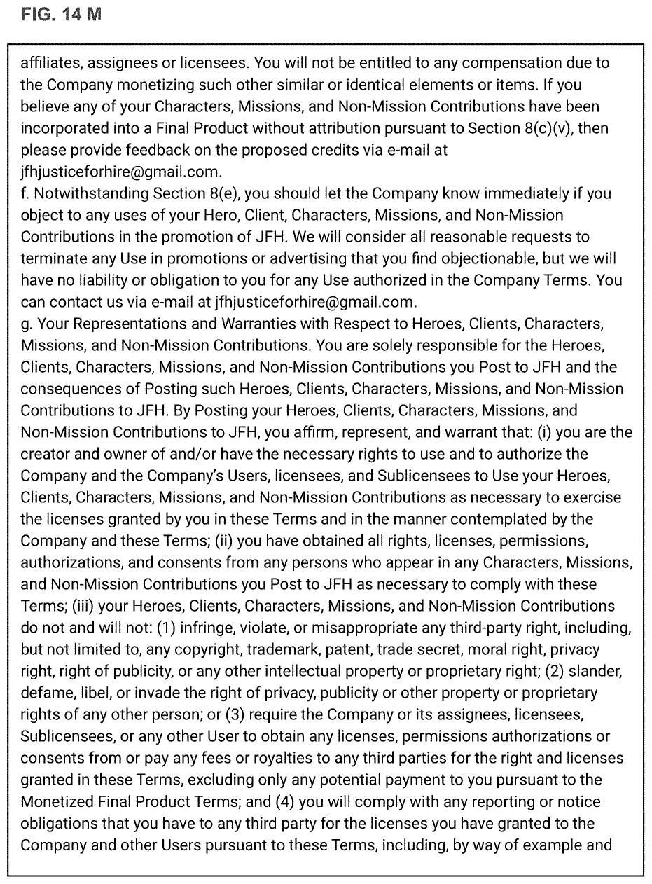

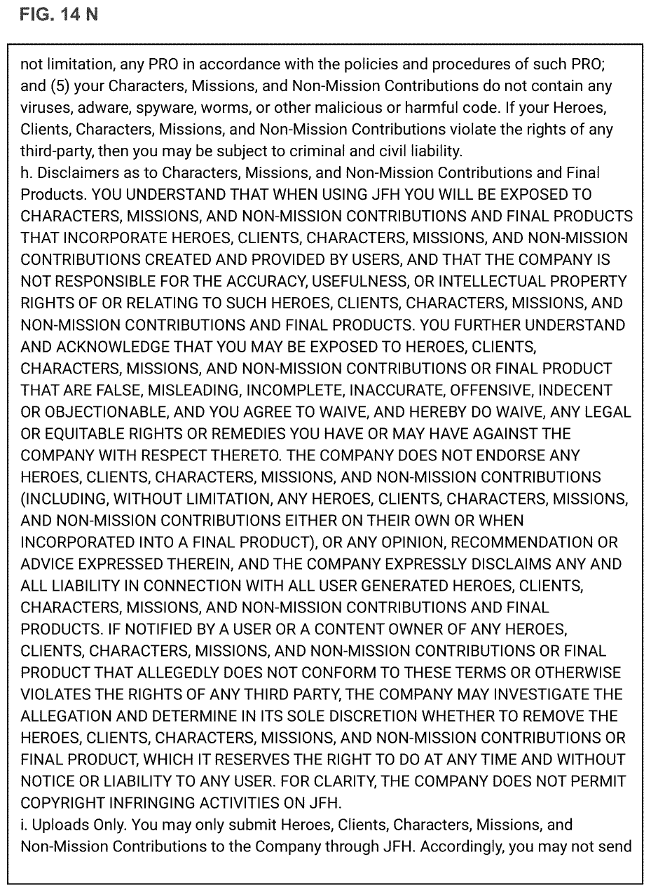

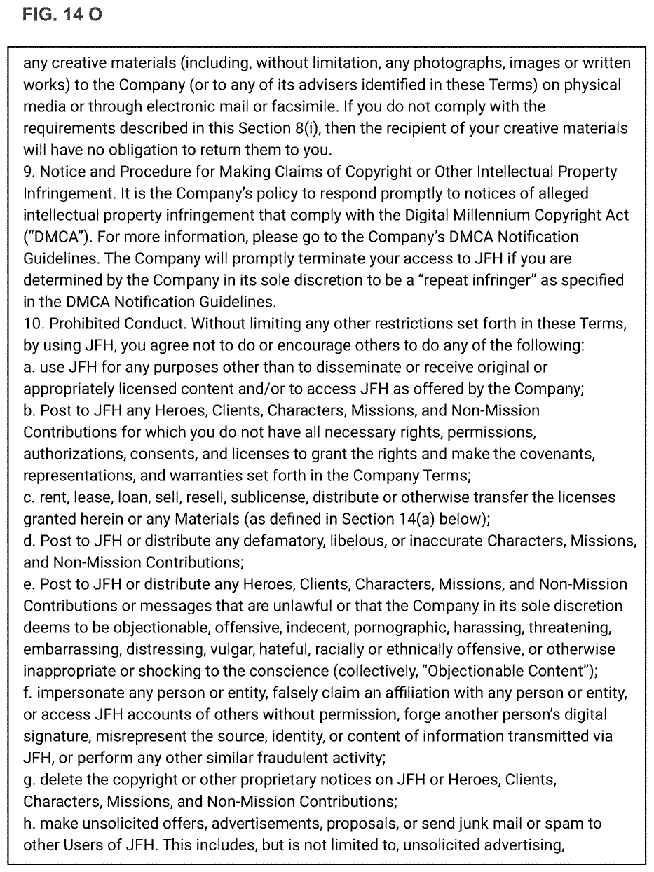

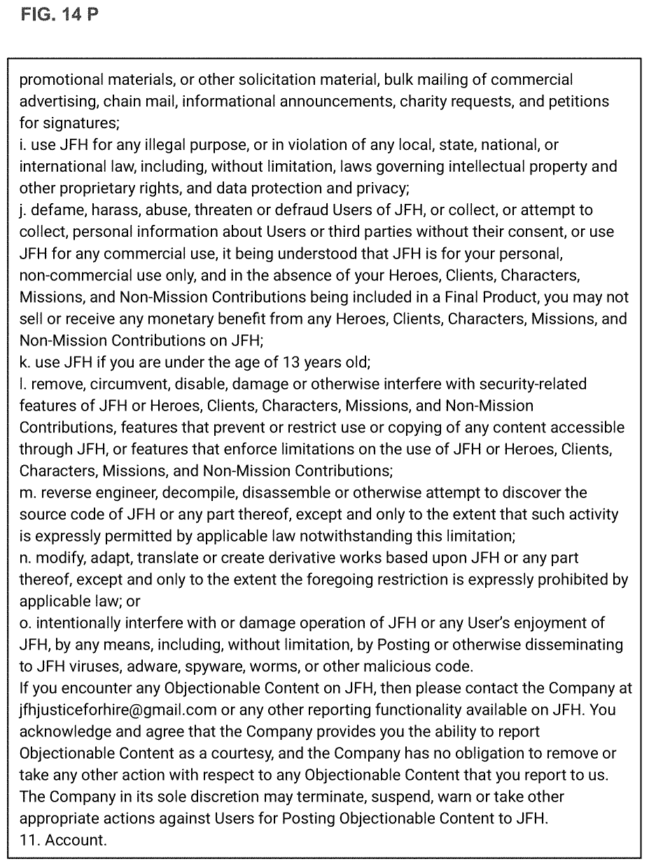

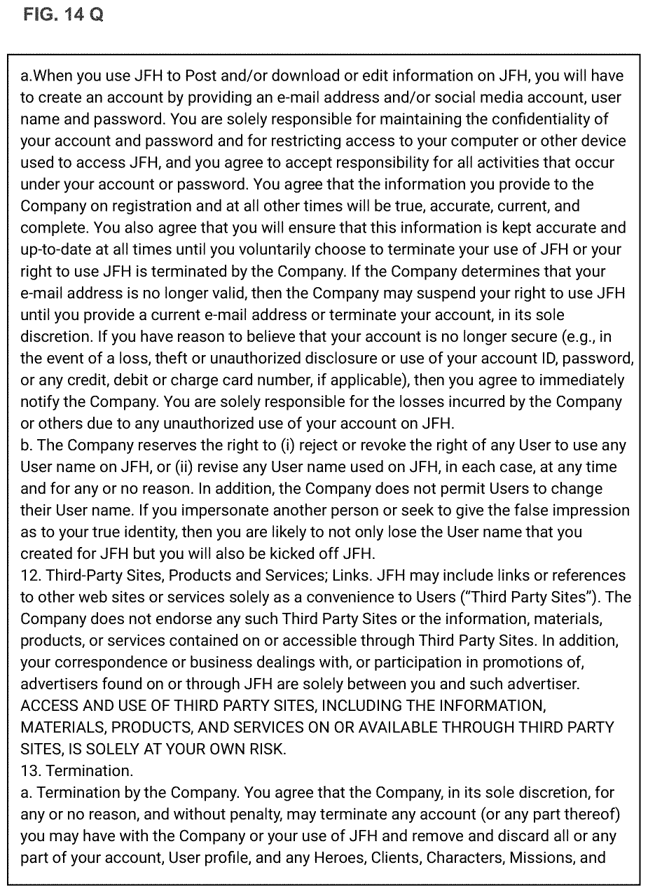

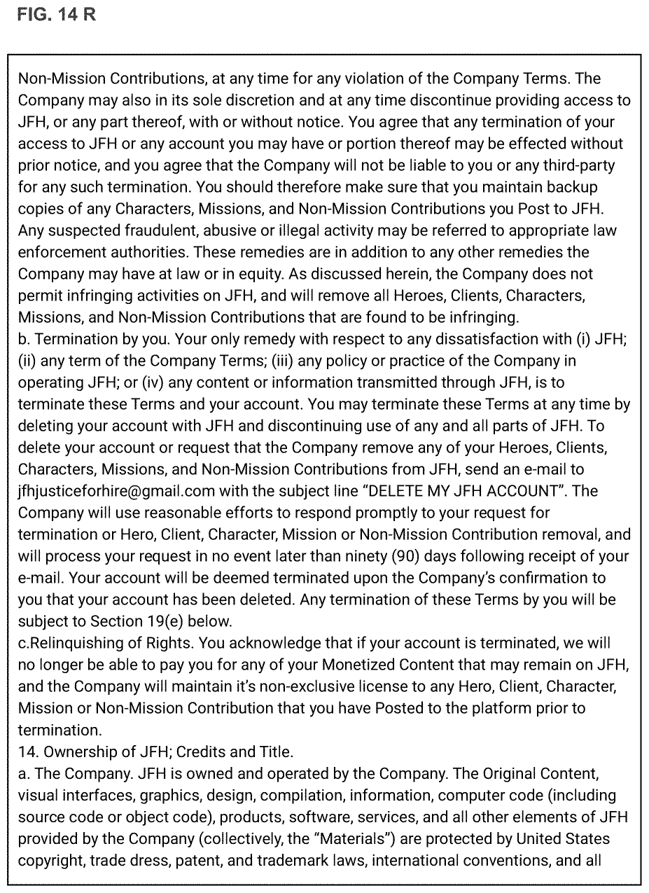

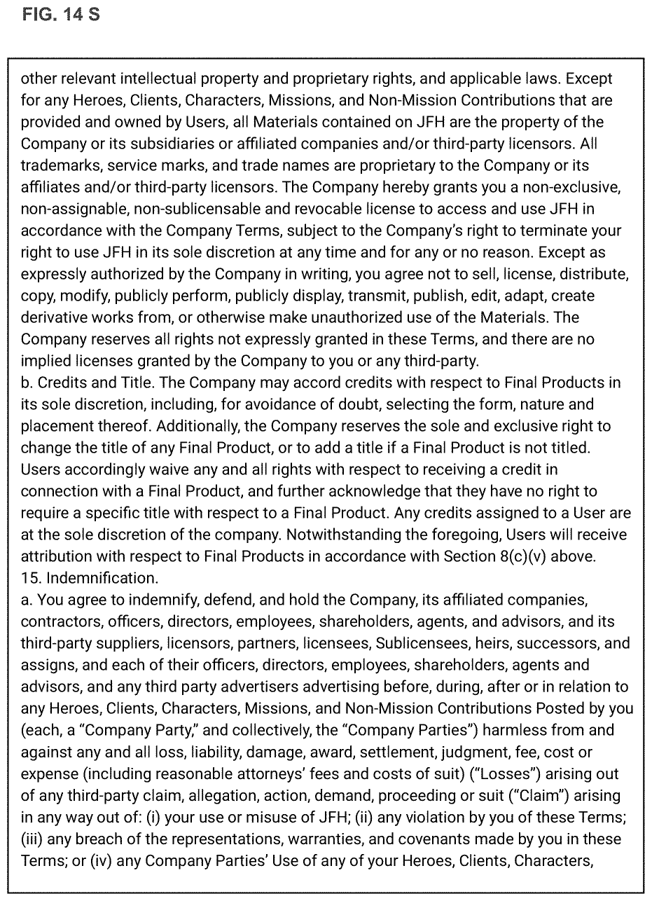

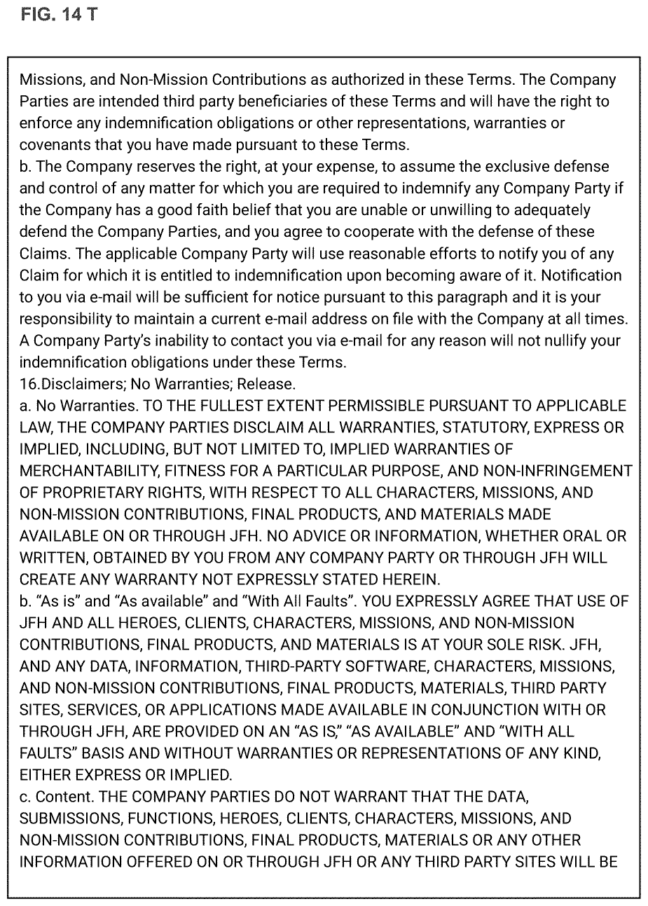

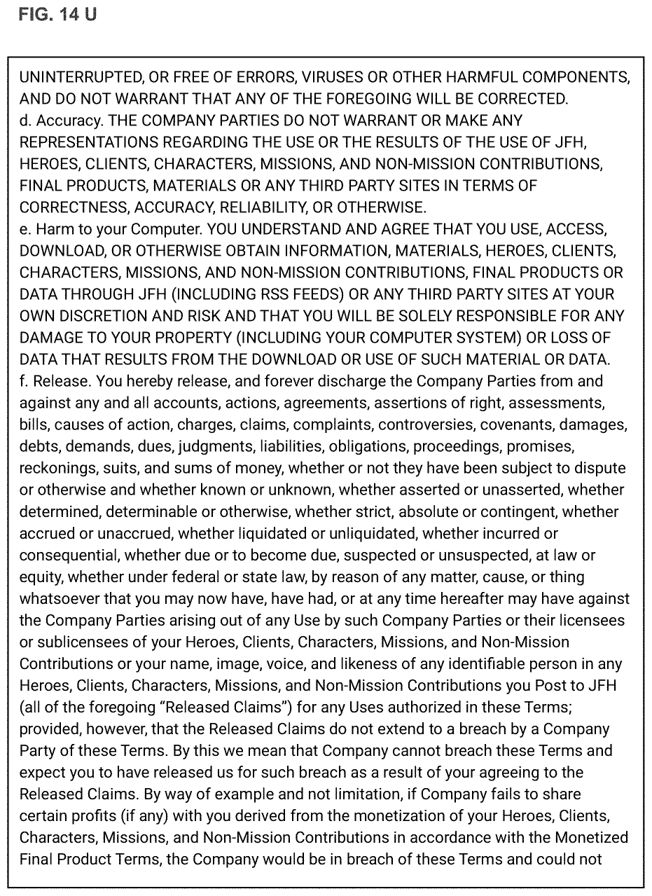

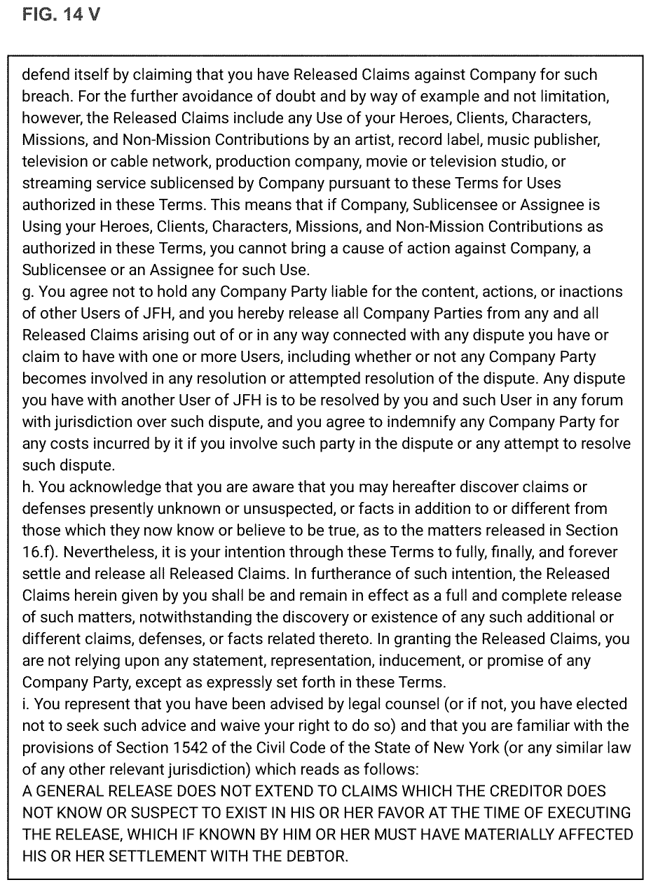

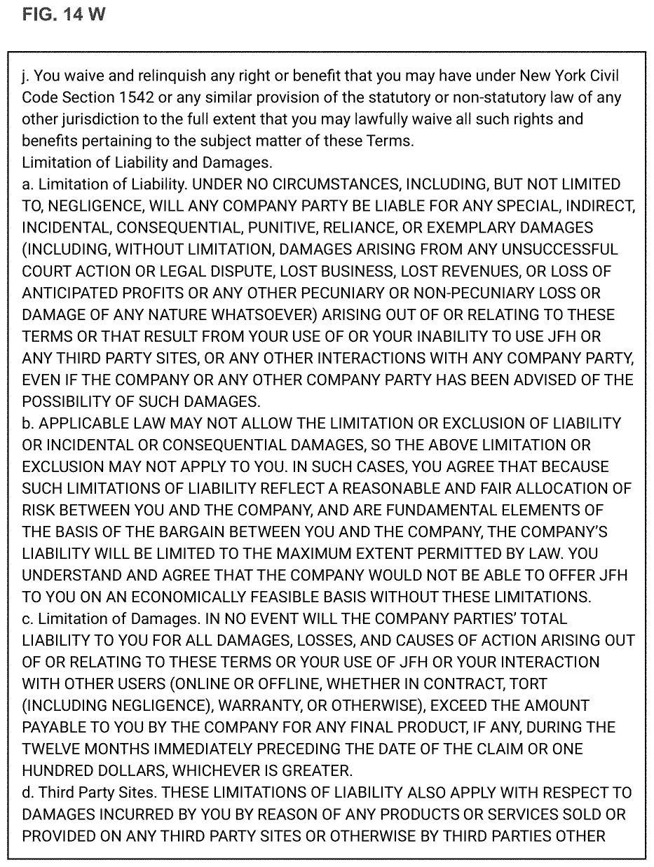

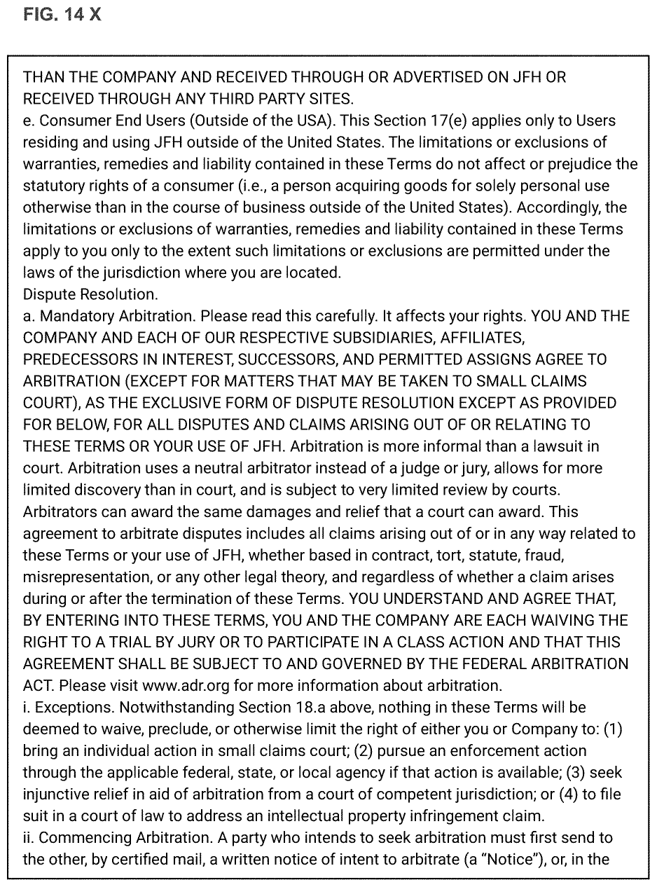

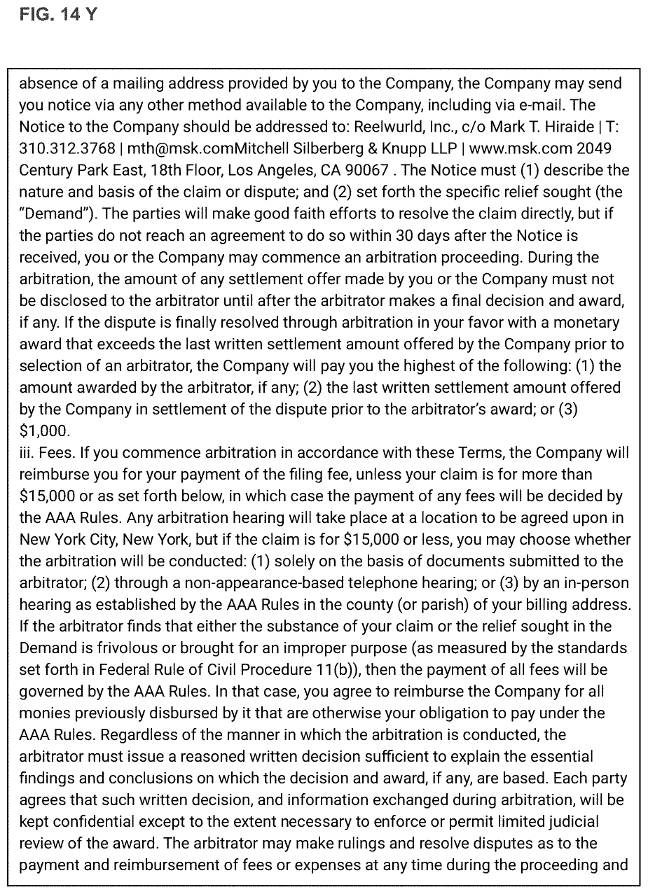

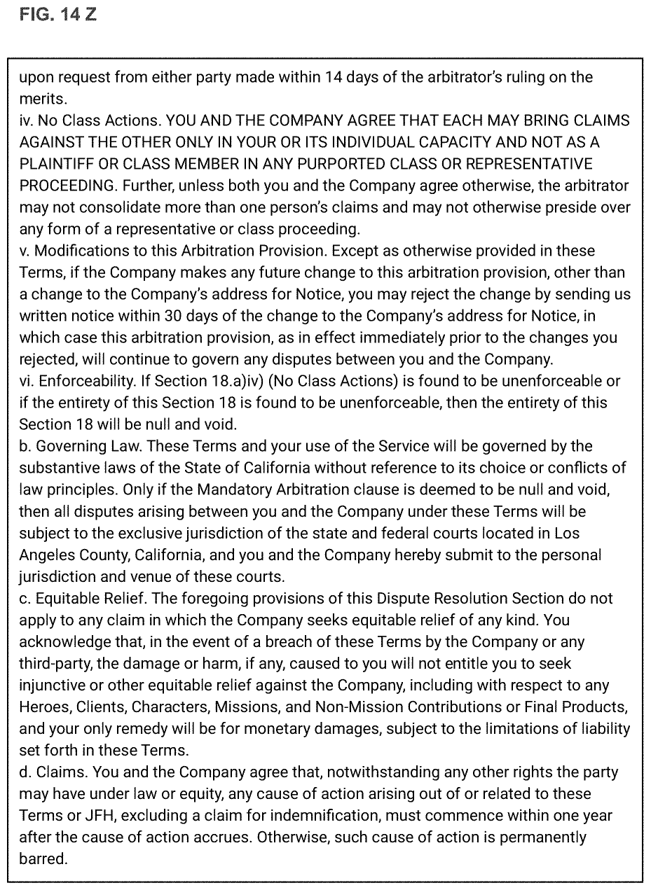

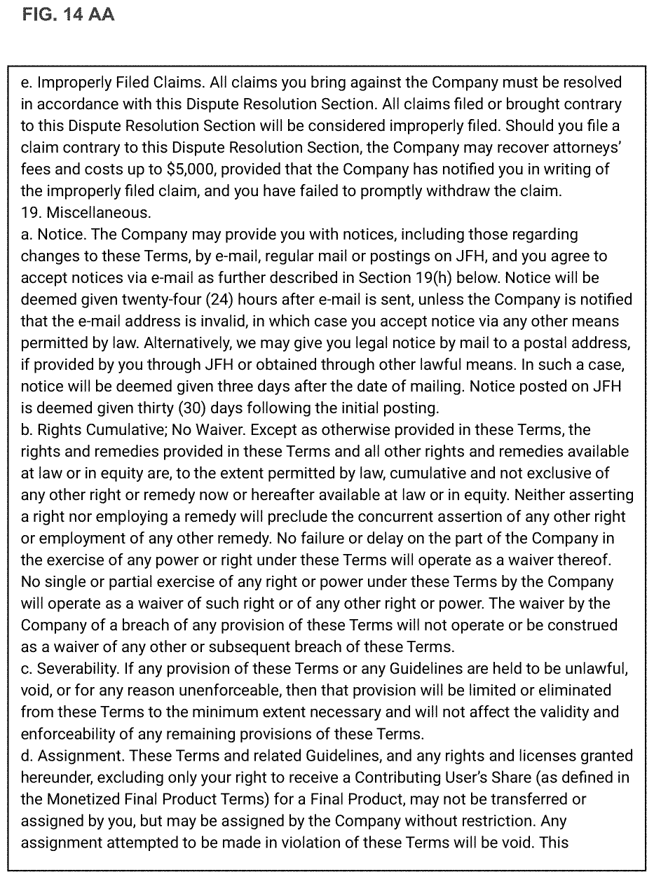

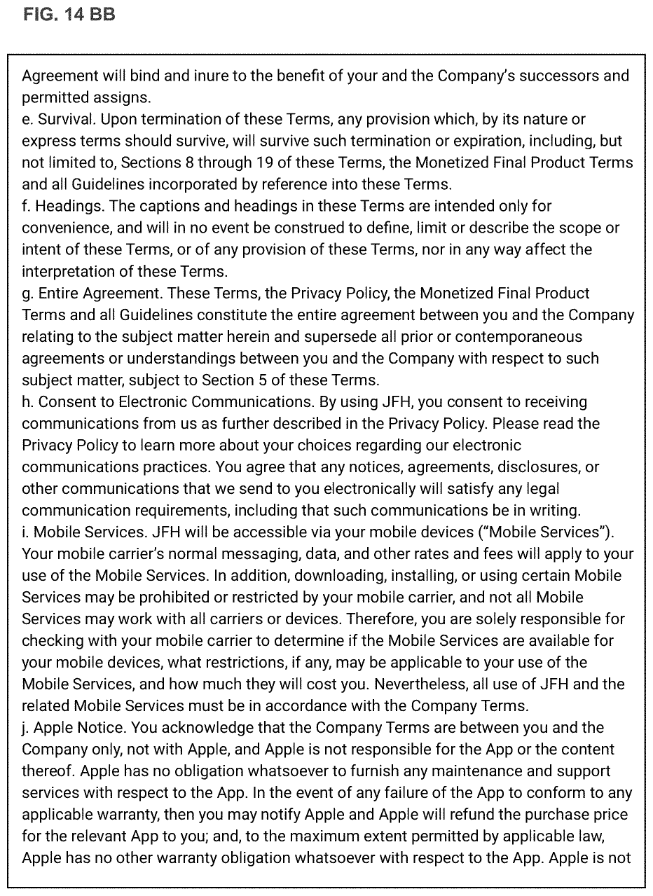

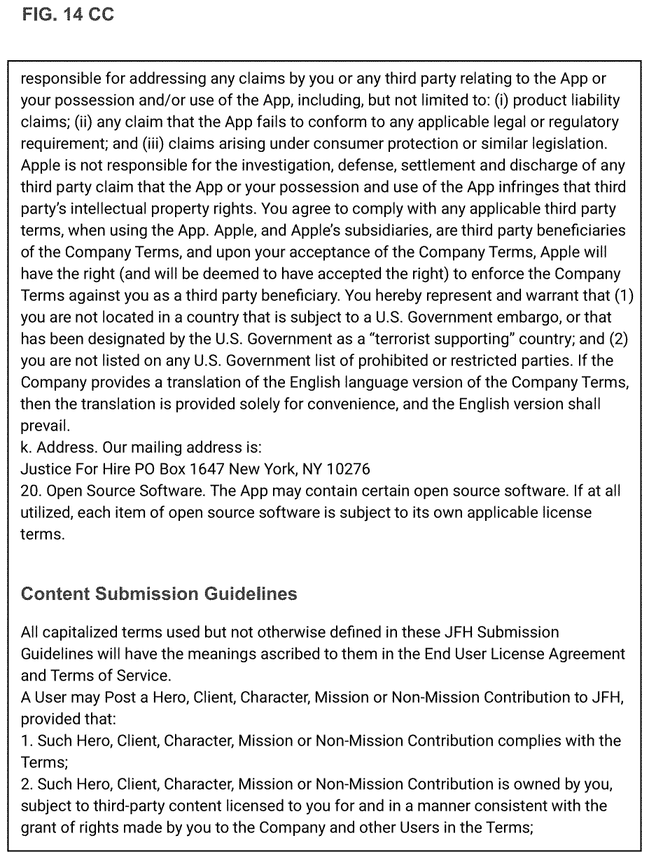

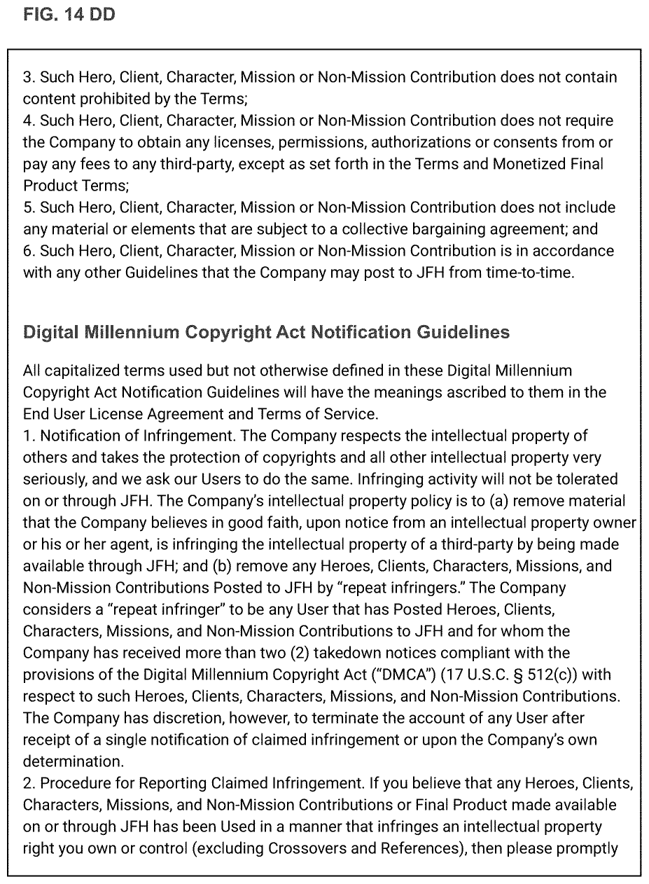

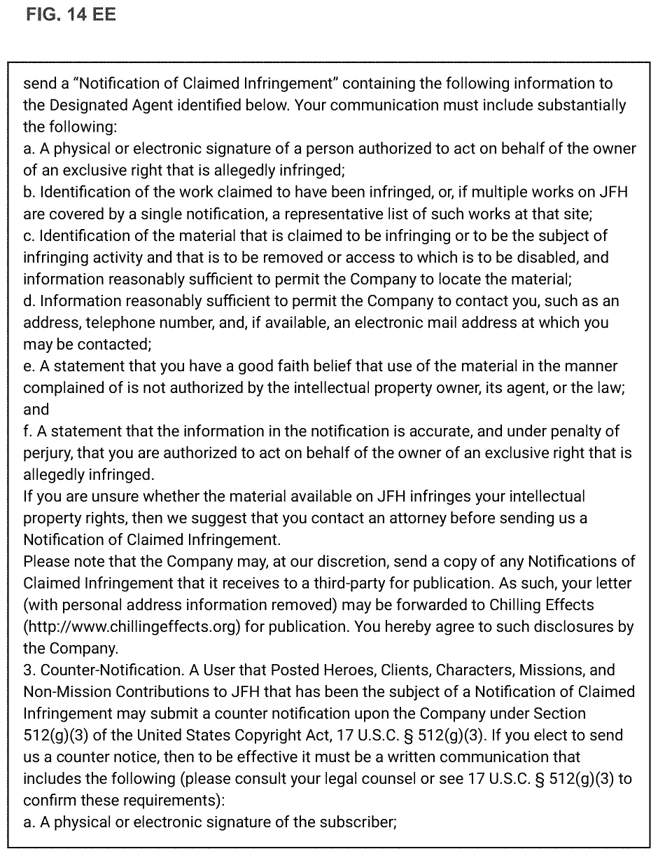

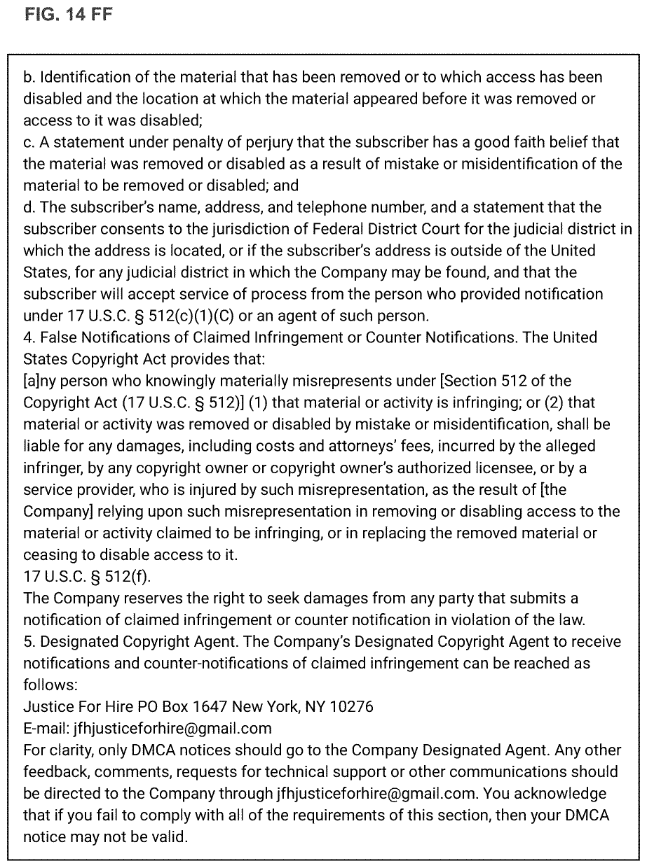

FIG. 14A-14 FF is an embodiment of the Terms of Service, to articulate unique aspects of the invention's processes.

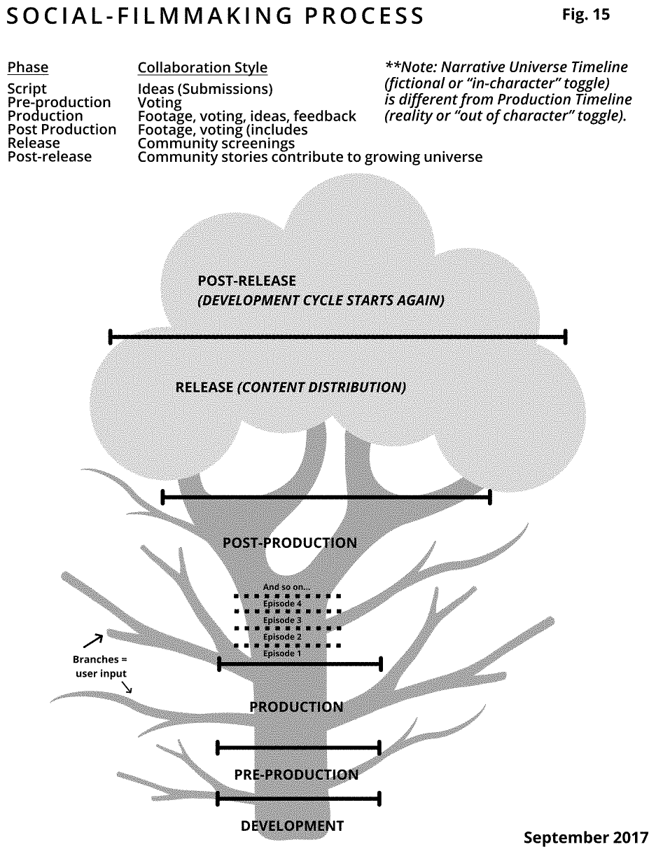

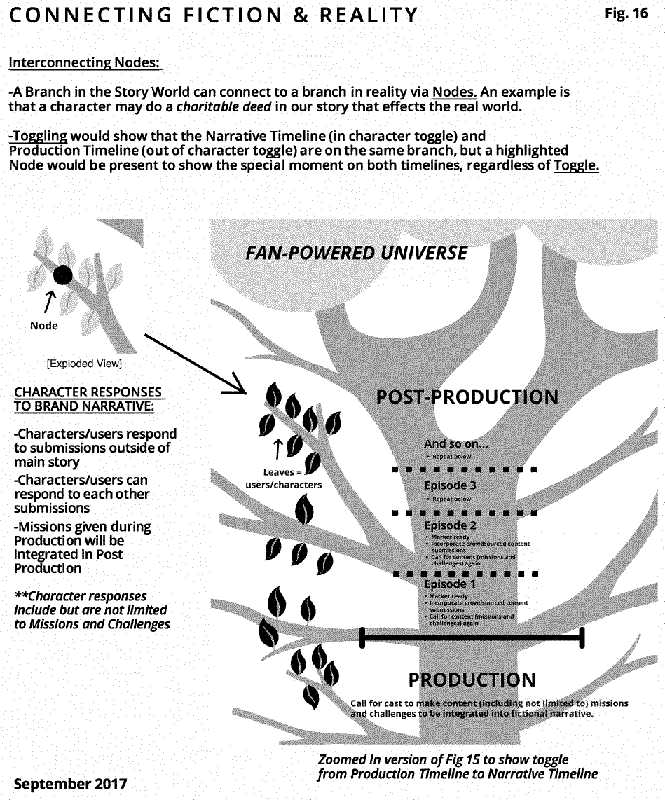

FIG. 15 is an embodiment of the first diagram described in claim 8.

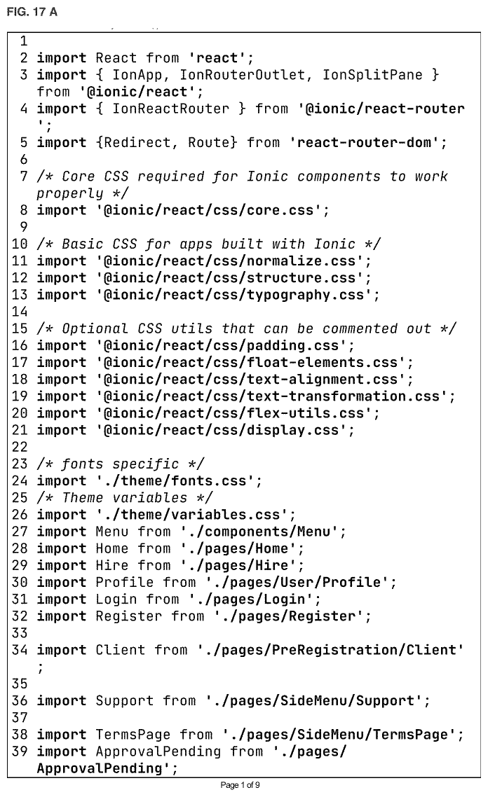

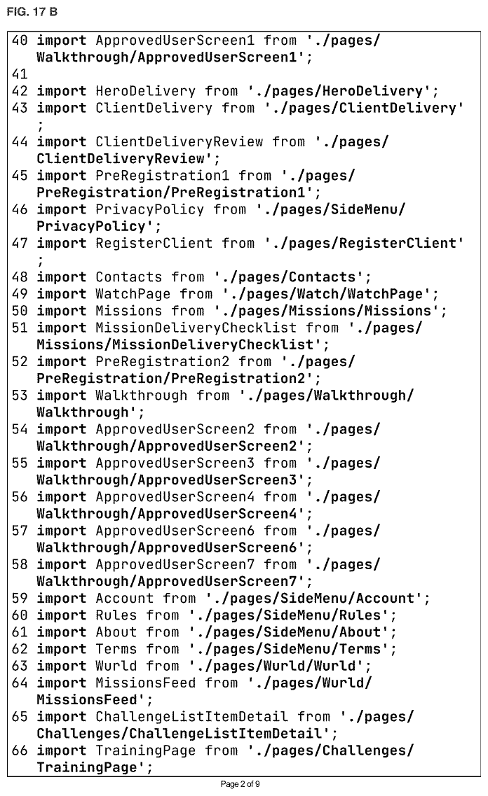

FIG. 16 is an embodiment of the second diagram described in claim 8.

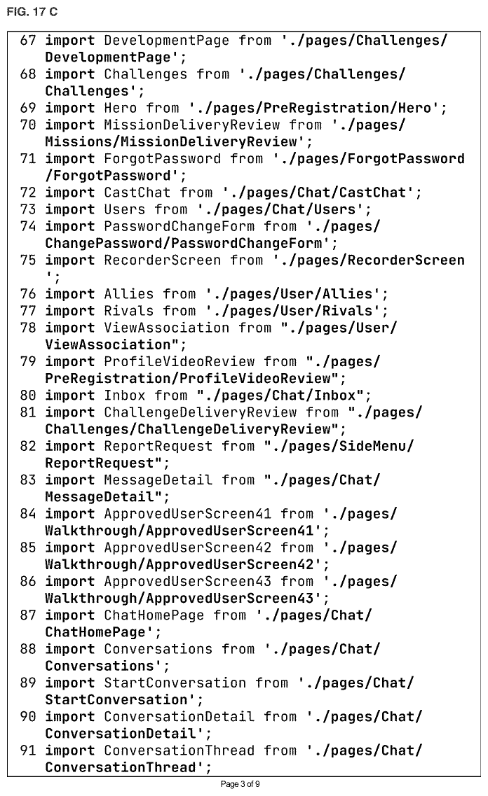

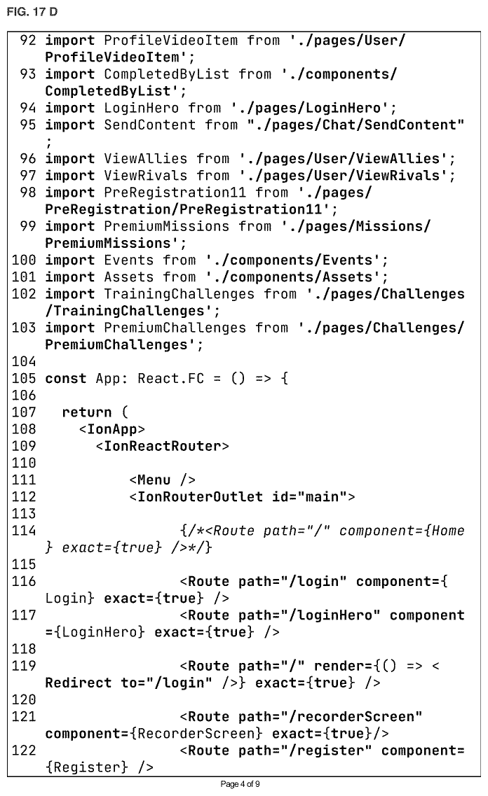

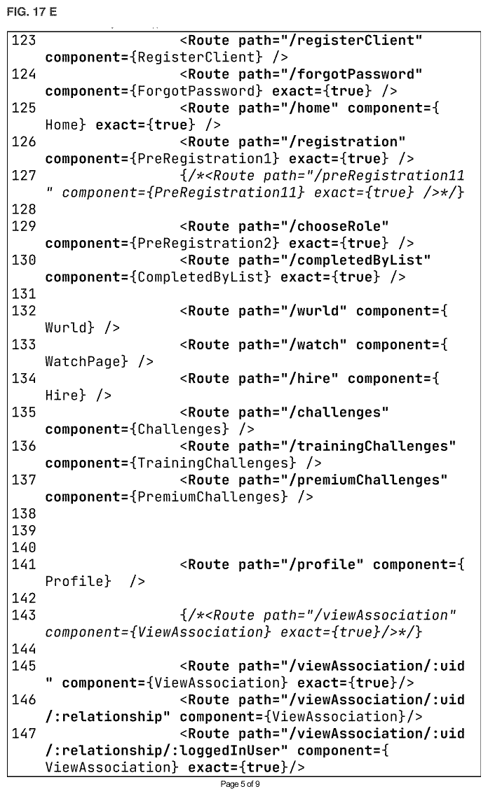

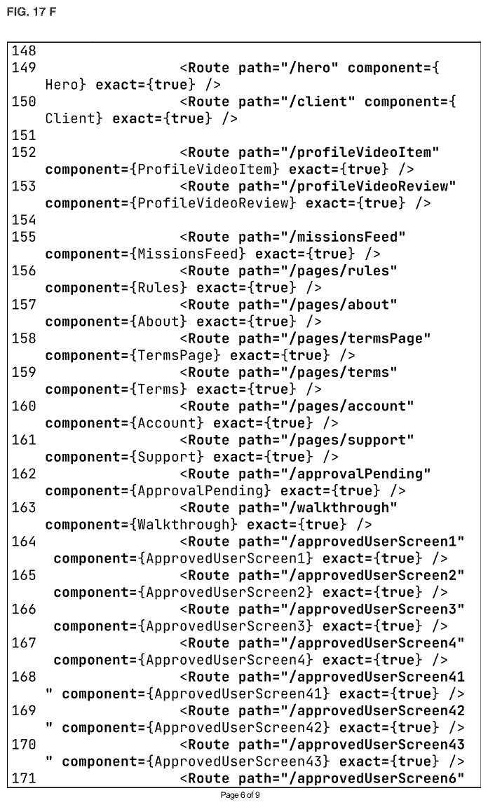

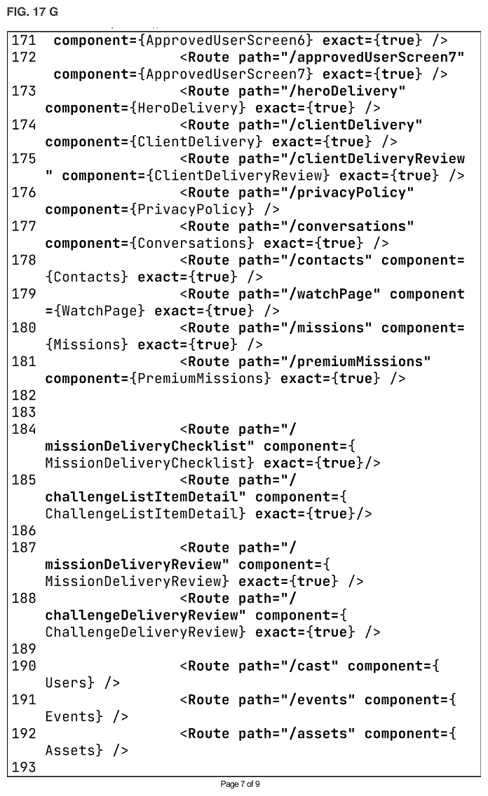

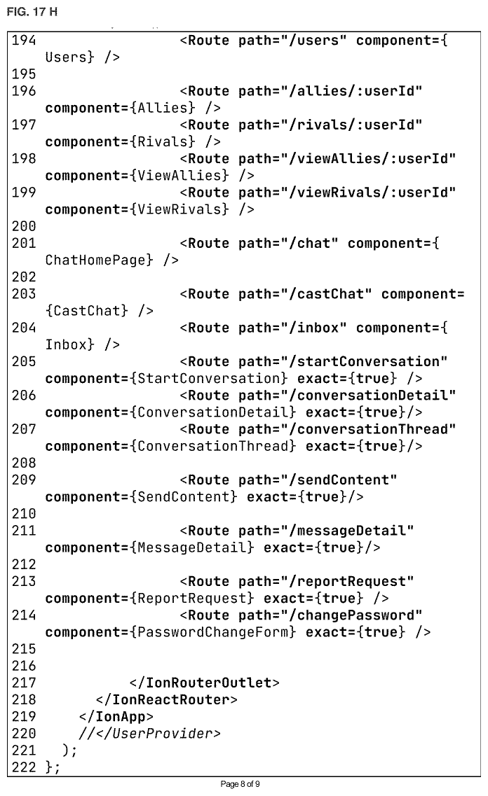

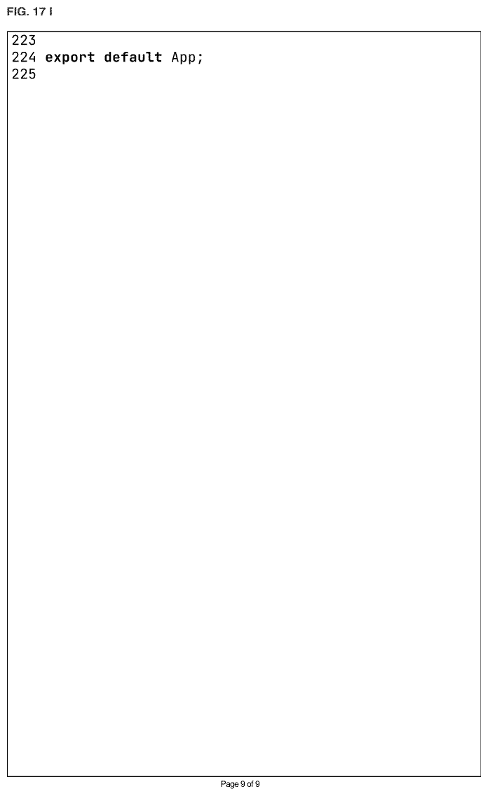

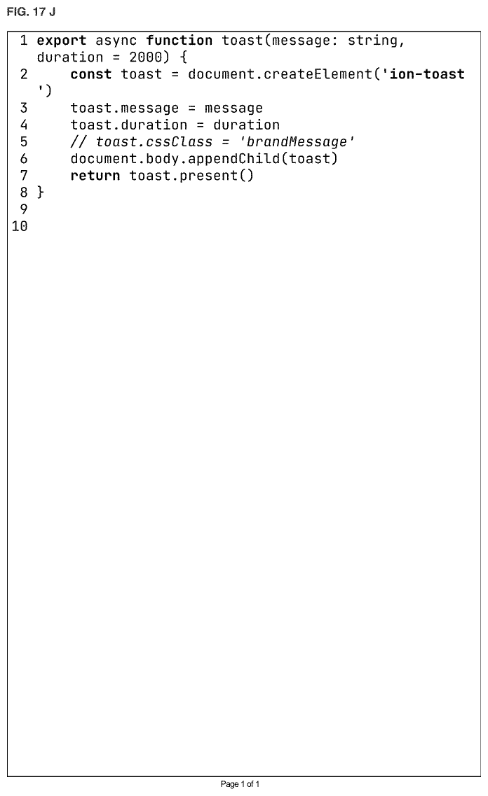

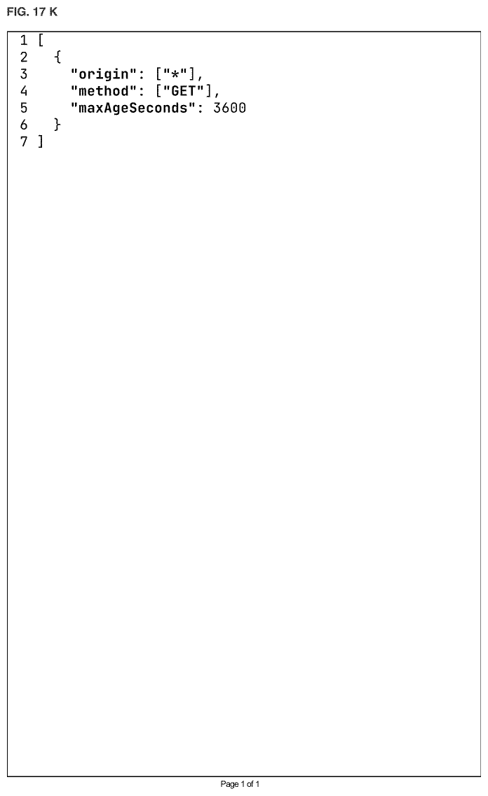

FIG. 17A-17 K is an embodiment of the source code written to enable the invention's system in the form of an app & online digital platform across electronic devices including, but not limited to mobile smart phones, tablets, and computers.

### DETAILED DESCRIPTION

In the following description, for purposes of explanation, numerous specific details are set forth in order to provide a thorough understanding of embodiments described herein. It will be apparent, however, to one skilled in the art and business, that certain embodiments may be practiced without these specific details. However, the invention's unique combination of processes and the simplification and reframing of them allows for filmmaking and storytelling to be utilized in a manner inclusive to audience creativity in a manner unachievable prior to the invention. Any and all titles used throughout are for ease of explanation only and are not for any limiting use.

An initial step in the use of the invention can include, but is not limited to, the invention's owner confirming a client's (for example, a brand) specific product-narrative and intended audience, and once confirmed, the invention's owner applying the product-narrative's unique message into the invention's system as per the following embodiments.

For purposes of clarifying a use case for the invention's system as applied to a product-narrative, the owners of the invention will at times be referencing within the application an example of a product-narrative in the form of the inventor-owned brand, Justice For Hire (“JFH”). The JFH logo and graphics will be present on some of the figures to showcase the invention's systems in practice (FIG. 3-FIG. 15). Additionally, naming conventions for select system functionalities will be given along with a variation specific to the JFH product-narrative to showcase that, while functionalities can be renamed for numerous iterations of a consumer-facing embodiment of the invention, including, but not limited to paper, cards, video, a website, app, or online digital platform as required by a brand's product-narrative, the functionality remains a unique component of the invention's system.

Thus, the invention can be customized in a variety of formats, including, but not limited to paper, cards, video, a website, app, or online digital platform to represent any brand or product and their respective audiences.

FIG. 1 depicts an embodiment of the invention for general conversation purposes, intentionally leaving out the greater details of the invention's systems and methodologies. Use cases for this embodiment include, but are not limited to, sales presentations to potential customers. In A, brand content (for example, a client's product-narrative) is clarified and utilized in the outreach efforts to its audience. The content, or some variation of it produced with or without the assistance of the owner of the invention, may be included in, but not limited to, distribution and display on the invention's system in the form of the application (i.e. the “app”) & online digital platform. It is important to note that the invention's system can operate with or without a specific piece of brand content. The brand content A is used here to clarify the value proposition of the invention for potential customers. B depicts the invention's system in the form of the app & online digital platform (in this simplified example, on the screen of a mobile smart phone, with a graphic unique to a brand) to showcase the invention as a pivotal part of the relationship between brand content and its intended audience. It also depicts the end-user joining the product-narrative. C depicts end-user interaction and declaration of relationship statuses when utilizing the invention. D depicts end-user content creation guided by story prompts within context of the Product Narrative and protocol of rules E depicts that audience content creation is informed by, tailored to, and expands upon the brand content as part of the value proposition of utilizing the functions of the invention.

FIG. 2 depicts an embodiment of the invention's system in the form of the app & online digital filmmaking and crowdsource technology platform. Embodiment is specifying one of many variations of information hierarchy that the system articulates for the end-user (i.e. individual participating audience members utilizing the app and/or platform) and a given product-narrative.

A1 depicts the journey of a “first time user” during initial use of the app and/or online digital platform. In one of many variations of the invention's system, a product-narrative may require approval of end-users before they are granted access to the full app and/or online platform. In the event of that scenario, the embodiment refers to this “first time user” process as the (“Pre Approval” flow (in JFH), while otherwise referred to as the Onboarding flow in the invention's system. The flow here is comprised of Directorial Guidelines as per the processes and style of the invention's system, and includes prompts for the end-user to produce their first audio/visual piece of content using the system (optional to the user in the JFH embodiment FIG. 3).

B1 depicts the Tutorial flow (“Post Approval” flow in JFH), which is utilized in this variation of the invention's system prior to the end-user gaining access to the invention's system in the form of the app & online digital platform with permissions to utilize all consumer facing functionalities. In the event that the product-narrative does not require a Post Approval flow, the information hierarchy can be repurposed as a Tutorial accessible to an end-user after Login.

0 depicts the Login Page that all end-users will utilize to access the invention's system in the form of the app & online digital platform. A first-time user, or an approved end-user if Pre Approval and Post Approvals flows are utilized, will enter their username and password here along with date of birth while a returning user will enter their pre-established login credentials.

1 depicts the Wurld Page is where user-generated content produced from both Product-Narrative Prompts and Audience-Narrative Prompts are displayed together (a variation of the Wurld Page differentiates content-type by color and/or naming convention). Additionally, a variation of the Wurld Page can contain community updates including, but not limited to events. Visualized in FIG. 9.

2 depicts the Watch Page, in which the brand content is thematically positioned as a driving force for the product narrative in which the end-user is participating. It is the consumer-facing language utilized within the invention's system that strategically positions this page as a key representation of the product-narrative. Variations will include, but are not limited to, user-generated content highlighted by the brand, as well as any product-narrative themed content deemed special by the brand. Visualized in FIG. 10.

2b-1 depicts the Universe function in which the end-user can identify and interact with characters from each episode or piece of audio-visual content, see any Challenges/Missions connected to the episode or piece of audio-visual content, and see individual pieces of content that were used in the episode.

3 depicts the Product-Narrative Prompts flow (named “Missions” in JFH), which is focused on delivering brand-narrative prompts to the end-user. Here, the end-user can participate in content creation that canonically influences the product-narrative. In one of many variations of this page, the end-user can also receive brand-approved prompts from third parties, or other end-users, to produce content that impacts the product-narrative and/or the real world.

In one of many variations of this page, end-users can choose to create a Story Prompt for distribution to other users, or to receive a Story Prompt which directs them to produce content. All prompts delivered on the Product Narrative Prompts Page are crafted in audio/visual form as per the guidelines of the invention's systems' interpretation of the product-narrative.

3a-b depicts the end-user's Prompt Options Page (“Hero/Client Options” Page in JFH. For a graphical representation, reference FIG. 5) to either a) Produce a Story Prompt for other end-users, (named the “Hire a Hero” flow in JFH. For a graphical representation, reference FIG. 6), or b) Receive a Story Prompt from the product-narrative or another end-user (named the “Hero” flow in JFH. For a graphical representation, reference FIG. 7).

3a-1 depicts the Directorial Guidelines for an end-user to create a Story Prompt for other end-users (For a graphical representation, reference FIG. 6). Here, the system will ask questions that are thematic to the product-narrative that the end-user will answer and expand upon by producing content that includes, but is not limited to audio/visual, text, and video content creation. The Record button on this screen (at times, named the “Action” button in JFH) opens the camera function on an end-user's phone, tablet, or computer 3a-2, and, alternatively, the end-user has the option to upload original content created independently from the invention's system via the Upload button as long as the original content follows the product-narrative Universe Rules 5a-1.

3a-3 depicts the Review/Submit Page where the end-user reviews the content created via the camera function or uploaded and chooses a thumbnail (preview) image for display in the Delivery Module of the Story Prompt (For a graphical representation, reference FIG. 6). Upon pressing the Deliver button, the Story Prompt is delivered for distribution on, but not limited to the app & online digital platform via the Delivery Module.

3b-1 depicts the Product-Narrative Prompt Selection Page for an end-user to choose a Product-Narrative Prompt or a Story Prompt generated by a brand-approved third party or other end-users. The Delivery Module for each prompt is populated with a brief description of the content.

3b-2 depicts the Directorial Guidelines for an end-user to produce content for a Product-Narrative Prompt or a Story Prompt. Here, the guidelines are thematic to the product-narrative that the end-user will utilize in producing audio/visual, text, and video content creation. The Record button on this screen (named the “Action” button in JFH) opens the camera function on an end-user's phone, tablet, or computer 3b-3, and, alternatively, the end-user has the option to upload original content created independently from the invention's system via the Upload button as long as the original content follows the product-narrative Universe Rules 5a-1.

3b-4 depicts the Review/Submit Page where the end-user reviews the content created via the camera function or uploaded and chooses a thumbnail (preview) image for display in the Delivery Module. Upon pressing the Deliver button, the content is delivered for distribution on, but not limited to the app & online digital platform via the Delivery Module.

4 depicts the Audience-Narrative Prompts Page (“Challenges” flow in JFH, with a graphical representation found in FIG. 8) which allows the end-user to focus on creating content around their chosen role, which does not require the content to have a direct canonical impact on the product-narrative. Audience-Narrative Prompts are designed by the invention's system to empower the end-user with a greater understanding of their chosen roles, which allows them to produce higher quality content for the product-narrative.

4a depicts Journey Challenges, which, by design of the invention's system, truncate a Hero's Journey storytelling model into short Audience-Narrative-Prompts that allow the end-user to produce scenes that are viewable independently within, but not limited to, the app & online digital platform distribution system, and when watched in sequence, equate to their own movie. Each Journey Challenge has unique Directorial Guidelines designed by the system's processes and displayed within a prompt to the end-user. In the referenced variation of this function in FIG. 8, end-user may receive this prompt prior to pressing the Record button to produce the audio/visual content.

4b depicts Training Challenges that allow the end-user to take on tasks that develop aspects of their chosen role including but not limited to emotional, mental, physical, and spiritual attributes associated with their character, alter ego and/or themselves. The tasks are delivered via prompts the end user accepts, followed by Directorial Guidelines delivered via additional prompts (a graphical representation of the prompt found in FIG. 8) to produce audio/visual content of themselves performing the tasks.

4c depicts Development Challenges that afford the end-user creative tasks including, but not limited to, traditional Hollywood story development processes simplified to allow the end-user to build an in-depth narrative about their character. The tasks are delivered via prompts the end user accepts, followed by Directorial Guidelines delivered via additional prompts (a graphical representation of the prompt found in FIG. 8) to produce audio/visual content of themselves performing the tasks.

4a-c-1 depicts Directorial Guidelines for an end-user to produce content for a Audience-Narrative Prompt or a Story Prompt. The Record button on this screen (named the “Action” button in JFH) opens the camera function on an end-user's phone, tablet, or computer 4a-c-2, and, alternatively, the end-user has the option to upload original content created independently from the invention's system via the Upload button as long as the original content follows the product-narrative Universe Rules 5a-1.

4a-c-3 depicts the Review/Submit Page (graphical representation found in FIG. 8) where the end-user reviews the content created via the camera function or uploaded and chooses a thumbnail (preview) image for display in the Delivery Module. Upon pressing the Deliver button, the content is delivered for distribution on, but not limited to the app & online digital platform via the Delivery Module.

5 depicts the Profile Page (visualized in FIG. 11), which stores all content generated by the end-user. On this page, the content generated by the end-user is organized between content produced via the product-narrative prompts, content produced from audience-narrative prompts, and various text fields in which the end-user is able to express the uniqueness of the character.

This page is viewable to the first-party end-user and a third-party end-user. A first-party end-user will see all consumer facing information, as well as have the opportunity to edit multiple fields of text and audio/visual content, including but not limited to the Allies/Rivals function.

A field for team affiliation is also available for the end-user to associate themselves with other groups of end-users via a chosen team name that may or may not be established by other content or functionalities within the system.

The Allies/Rivals function is a means of organizing the character relationships between end-users that have chosen to associate with each other on the platform, by way of, but not limited to, selecting a role for the peer-to-peer relationship.

7a depicts the Hamburger Menu, which contains both general information and unique information such as the Universe Rules, Cast (5a-1 and defined in FIG. 13) and Terms of Services (5a-5 and defined in FIG. 14).

6 depicts the Chat Function (visualized in FIG. 12), which allows end-users to have peer-to-peer interactions. In Chat, the toggle function allows the end-user to choose between sending messages “in-character” (i.e. their chosen role) or “out-of-character” (i.e. as the end-user's true identity).

FIG. 3 depicts an embodiment of the Onboarding flow (“Pre Approval” flow in JFH, referencing FIG. 2, A1) using the example of the JFH product-narrative on the invention's system in the form of the app & online digital platform. Embodiment is specifying one of many variations of information hierarchy that the system articulates for the end-user, starting with: A the Summary of the product-narrative, B the Choose a Role function, allowing the user to participate in the product-narrative in capacities approved by the brand (If this function of the invention's system is utilized, the end-user's profile on the app & online digital platform may include, but is not limited to, the information associated with the chosen role, and prompts received by the given end-user, and content produced by the given end-user may be also influenced by and associated with the chosen role), C, D, and E variations on the first content creation prompt an end-user receives, whether or not a role was chosen, and end-user has the option to press the Record button (“Action” button in JFH) which opens the camera function on an end-user's phone, tablet, or computer, and, alternatively, the end-user has the option to either upload original content created independently from the invention's system via the Upload button as long as the original content follows the product-narrative Rules 5a-1, or continue without creating any content at all, and F the Pending Approval page if the Pre Approval function is utilized. If the Pending Approval function is not utilized, variations of the invention's system may allow the end-user access to the full consumer facing functionality of the app & online platform 1, or place the end-user on 0 the Login page.

FIG. 4 depicts an embodiment of the Tutorial flow (“Post Approval” flow in JFH, referencing FIG. 2, B1) using the example of the JFH product-narrative on the invention's system in the form of the app & online digital platform. Embodiment is specifying one of many variations of information hierarchy that the system articulates for the end-user, starting with: A the Welcome message, accompanied by a prompt to record a video for a Role if one has not been chosen thus far, B a brief description of the functionalities of the app & online platform customized to the language associated with the product-narrative, C, D, and E examples of the various types of content an end-user can produce based on prompts and directorial guidelines from the invention's system, F an explanation of the Chat and Chat Toggle functionalities, and G a send off message from the product-narrative.

FIG. 5 is an embodiment of the end-user's Prompt Options Page (“Hero/Client Options” Page in JFH, referencing FIG. 2, 3a-b) to either a) Produce a Story Prompt for other end-users, (named the “Hire a Hero” flow in JFH), or b) Receive a Story Prompt from the product-narrative or another end-user (named the “Hero” flow in JFH).

FIG. 6 is an embodiment of the Produce a Story Prompt flow (named the “Hire a Hero” flow in JFH), containing graphical representations of the functionalities described for FIGS. 2, 3a-1, and 3a-3.

FIG. 7 is an embodiment of the Receive a Story Prompt flow (named the “Hero” flow in JFH) containing graphical representations of the functionalities described for FIGS. 2, 3b-1, 3b-2, and 3b-4.

FIG. 8 is an embodiment of the Audience-Narrative Prompts flow (named the “Challenges” flow in JFH) containing graphical representations of the functionalities described for FIGS. 2, 4, 4a, 4b, 4c, and 4a-c-1.

FIG. 9 is an embodiment of the Wurld page containing graphical representations of the functionalities described for FIG. 2, 1.

FIG. 10 is an embodiment of the Watch page, containing graphical representations of the functionalities described for FIG. 2, 2.

FIG. 11 is an embodiment of the Profile Pages for a product-narrative participation role chosen by an end-user, containing graphical representations of the functionalities described for FIG. 2, 5.

FIG. 12 is an embodiment of the Chat Function, containing graphical representations of the functionalities described for FIG. 2, 6.

FIG. 13 is an embodiment of the Universe Rules (referenced in FIG. 2, 5a-2), which the invention's system references and utilizes for a plethora of functionalities, including, but not limited to, Directorial Guidelines crafted using filmmaking, storytelling, and gaming mechanics, that serves as part of the baseline for the invention's unique value proposition. The Universe Rules serve as a template that can be modified and customized for a given brand or product-narrative.

FIG. 14A-14 FF is an embodiment of the Terms of Service (referenced in FIG. 2, 5a-5), which the invention's system references and utilizes for a plethora of functionalities, including, but not limited to ownership of the content produced on the app & online digital platform, that serves as part of the baseline for the invention's unique value proposition. The Terms of Service serve as a template that can be modified and customized for a given brand or product-narrative. To understand the scope of the importance of this Terms of Service document, it is the articulation of the audience participation that is laid out within these terms that is allowing the owner of the invention to operate the invention's system in all forms, and offer its functionalities for business purposes. It is a document containing key thinking and industry experience written within it that provides a legal foundation upon which all parties can participate.

FIG. 15 is an embodiment of a diagram mapping product-narrative over a period of time in relation to industry standard production and marketing processes for pieces of media, including, but not limited to a film or series of related films, TV shows, and commercials. Each stage of the industry standard process is listed in generalities on this image, using the imagery of a tree to visualize how a piece of media evolves and can include content crowdsourced from the end-users.

FIG. 16 is an embodiment of a diagram mapping product-narrative over a period of time in relation to the story itself, along with details on how to compare actions taken by the end-user in the story relate to real-world production schedules, events, and other material changes both inside and outside of the fictional story. This image represents a deeper look into FIG. 15 as it relates to pieces of media produced over time and organized into a particular story format, including but not limited to, episodes, scenes, feature-length films, or other formats.

FIG. 17A-17 K is an embodiment of the source code written to enable the invention's system in the form of an app & online digital platform across electronic devices including, but not limited to mobile smart phones, tablets, and computers.

What is claimed is:

1. A system for directing end-user audio-visual stories, which comprises:
at least one story prompt, comprised of audio-visual and/or text direction, that guides an end-user through filmmaking activities to generate audio-visual stories set within product-narratives that include, but are not limited to: a story from a film or series of related films, TV shows, commercials, and 3rd party user-generated content, which can be delivered to end-users in a format, including, but not limited to paper, cards, video, a website, app, or online digital platform.

2. The system of claim 1, further comprising at least one onboarding story prompt that directs end-user to create and/or portray a character thematically connected to the product-narrative by recording and/or uploading a video, and/or writing text to define the character's name and/or story attributes.

3. The system of claim 1, further comprising at least one product-narrative story prompt, that may include, but is not limited to, audio-visual and/or text description, that directs end-user to create and/or portray a character in a scene thematically connected to the product-narrative, and/or end-user's character's story, and/or a 3rd party end-user's story, by recording and/or uploading a video, and/or writing text to define story attributes.

4. The system of claim 1, further comprising at least one story prompt creation template enabling end-user to record an audio-visual story, which can include, but is not limited to writing supporting text descriptions to direct 3rd party end-user cinematic storytelling.

5. The system of claim 1, further comprising at least one profile to catalogue audio-visual and text activity, including, but not limited to background story and character information from an end-user, a means to list a relationship status with at least one 3rd party end-user with terminology that includes, but is not limited to, an “ally” or a “rival”, that is editable by the end-user and is visible to 3rd party end-users and the owner of the product-narrative.

6. The system of claim 1, further comprising a method for end-users to communicate with each other via audio-visual and/or text messages, and/or verbally, in-character, as their created personas, and out-of-character, as their true identities.

7. The system of claim 1, further comprising at least one protocol of rules, in a format that at least includes text, describing the intended behavior of end-users as related to the product-narrative and/or their usage of story prompts on the audio-visual storytelling system.

8. A method guiding owners of product-narratives, including, but not limited to, movie studios, TV networks, filmmakers, and brands, to direct end-users, including, but not limited to, fans and audience members of movies, TV shows, and commercials, through filmmaking activities to create audio-visual stories within the context of a extending product-narratives including, but limited to, the story of a film or series of related films, TV shows, and, commercials, which comprises:
the creation of a diagram mapping product-narrative over a period of time in relation to industry standard production and marketing schedules for pieces of media, including, but not limited to a film or series of related films, TV shows, and, commercials; and
the creation of a diagram mapping product-narrative over a period of time in relation to the story itself; and
comparing the two diagrams; and
designing story prompts based on the comparison, which can be delivered to end-users in a format, including, but not limited to paper, cards, video, a website, app, or online digital platform.

9. The method of claim 8, further comprising at least one list of current or upcoming pieces of media, and/or end-user audio-visual stories, and/or any combination thereof, in relation to the product-narrative, wherein a pertinent story prompt are available to the end-user.

10. A process to notify product-narrative owner of end-user interactions with the product-narrative, which comprises:
determining a character role chosen by end-user; and
determining the relationship status between at least two end-users; and
determining if end-user completed a story prompt; and
determining how many story prompts an end-user has completed; and
a product-narrative profile from which to communicate with end-users; and
sending at least one audio-visual and/or text notification to product-narrative owner's profile with results of determination; and
a repository for all end-user data collected as a result of the capabilities of the system in a format, including, but not limited to paper, cards, video, a website, app, or online digital platform.

11. The method of claim 10, further comprising at least one audio-visual and/or text notification delivered.
